(19) United States
(12) Patent Application Publication
(10) Pub. No.: US 2014/0215077 A1
(43) Pub. Date: Jul. 31, 2014

(54) METHODS AND SYSTEMS FOR DETECTING, LOCATING AND REMEDIATING A CONGESTED RESOURCE OR FLOW IN A VIRTUAL INFRASTRUCTURE

(71) Applicant: Lyatiss, Inc., Mountain View, CA (US)

(72) Inventors: Sebastien SOUDAN, Lyon (FR); Romaric GUILLIER, Lyon (FR); Marion LE BORGNE, San Francisco, CA (US); Pascale VICAT-BLANC, San Francisco, CA (US)

(73) Assignee: Lyatiss, Inc., Mountain View, CA (US)

(21) Appl. No.: 14/163,312

(22) Filed: Jan. 24, 2014

Related U.S. Application Data
(60) Provisional application No. 61/757,140, filed on Jan. 26, 2013.

(51) Int. Cl. H04L 12/801; H04L 12/911

(52) U.S. Cl. CPC H04L 47/11; H04L 47/74; H04L 47/822
USPC 709/226

(57) ABSTRACT

Once a potential bottleneck is identified, the system provides a methodology for locating the bottleneck. The methodology involves checking in order each of the application, transport and network layers of a sender and receiver nodes for performance problems. Conditions are defined for each of the layers at the sender and receiver nodes that are indicative of a particular type of bottleneck. When the conditions are met in any one of the layers, the system can be configured to stop the checking process and output a message indicating the presence of a bottleneck in the layer and its location. In addition, the system can be configured to generate and output a remedial action for eliminating the bottleneck. The system can be configured to perform the action automatically or after receiving a confirmation from the user.

### CROSS-REFERENCE TO RELATED APPLICATION

This application claims priority of U.S. Provisional Patent Application No. 61/757,140, entitled METHODS AND SYSTEMS FOR DETECTING, LOCATING AND REMEDIATING A CONGESTED RESOURCE OR FLOW IN A VIRTUAL INFRASTRUCTURE filed 26 Jan. 2013 by Sebastien SOUDAN, et al., which application is incorporated herein by reference in its entirety for all purposes.

### FIELD OF THE INVENTION

The invention relates to the area of managing virtual resources in a cloud or distributed environment. More particularly, the invention is related to a system and a user interface that provide modeling and visualization of end to end communication patterns, network traffic and real-time resource management in the context of virtual or physical networks.

### DESCRIPTION OF THE RELATED ART

In a cloud or distributed environment, applications are distributed and deployed over virtual resources that are dynamically provisioned and mapped to a pool of physical servers that are allowed to communicate in some manner through some type of physical network. From a customer perspective, the virtual resources are typically virtual machines that execute customer applications. The machines are “virtual” in the sense that 1) the underlying physical servers on which the virtual machines are operating can change over time (migration), 2) a variable number of virtual machines are running on the same physical server, sharing the underlying processor, memory, disk and network interface capabilities (sharing). Using the abstraction of a virtual machine, the changing nature of the physical servers is opaque to customer applications, yet, can cause the applications to experience variable and unpredictable performance.

The customer applications often include components that execute on different virtual machines that need to communicate with one another to complete a particular task. Thus, a virtual network is formed between the virtual machines where the performance of the virtual resources, including both the virtual network and the virtual machines, affects how quickly the particular task is completed within the customer application. The performance of the virtual resources is constantly changing and is difficult to characterize as the underlying physical resources are constantly changing. In addition, for a particular customer application, how the application interacts with the virtual resources affects the perceived performance of the virtual resources from the point of view of the application. This coupling between the application and the resources adds additional complexity to the performance characterization problem.

Every customer utilizing cloud resources wants to ensure that their applications are sufficiently optimized to meet the demands of their business at all times while not wasting resources. Optimization requires a dynamic characterization of cloud resource performance, which varies from application to application, resource management tools that allow user to respond to the performance characterization in a timely and appropriate manner. Currently, such tools are very limited or non-existent. In view of the above, new methods and apparatus for application specific cloud resource management are needed.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A system that allows users and organizations to access on-demand, and in a personalized way, performance and optionally flow activity measures of an end-to-end network of virtual resources is described. The system can be configured to generate and output metrics associated with virtual resources that can identify potential bottlenecks and congestion affecting system performance. The metrics can be mapped to the virtual resources in a visual format that is output as part of actionable user interface.

Once a potential bottleneck is identified, the system provides a methodology for locating the bottleneck. The methodology involves checking in order each of the application, transport and network layers of a sender and receiver nodes for performance problems. Conditions are defined for each of the layers at the sender and receiver nodes that are indicative of a particular type of bottleneck. When the conditions are met in any one of the layers, the system can be configured to stop the checking process and output a message indicating the presence of a bottleneck in the layer and its location. In addition, the system can be configured to generate and output a remedial action for eliminating the bottleneck. The system can be configured to perform the action automatically or after receiving a confirmation from the user.

In one embodiment, a method implemented in at least one electronic device including a processor and a memory is disclosed. The processor identifies virtual resources associated with an execution of a user's applications in a resource configuration, including virtual or physical machines, network services, and storage, and the resource configuration is a cloud or distributed resource configuration. Performance metrics associated with the execution of the user's applications in the resource configuration are generated. In the processor a visual representation of the resource configuration, including the virtual or physical machines and the performance metrics, is generated. Under control of the processor, a user interface, including the visual representation, is output. In the processor, it is determined that there is possibly a bottleneck involving a sender and a receiver of the virtual or physical machines based on the performance metrics.

The processor checks serially for a problem indicating a presence of the bottleneck in each of an application layer, transport layer, and network layer of the sender and the receiver. When a check indicates the problem is in one of the application layer, transport layer, or network layer of the sender or the receiver, the processor stops the checking and outputs a message to the user interface indicating a location of the bottleneck is in the sender or receiver and a recommendation for a remedial action for alleviating the bottleneck. When the checks indicate the problem is not located in any of the application layer, transport layer, or network layer of the sender or the receiver, the processor outputs a message to the user interface indicating the location of the bottleneck is in an external path between the sender and the receiver and a recommendation for a remedial action for alleviating the bottleneck in the external path or there is no problem.

In an alternative embodiment, the invention pertains to an apparatus for cloud or distributed computing resource management. The apparatus is formed from one or more electronic devices that are configured to perform one or more of the above described method operations. In another embodiment, the invention pertains to at least one computer readable storage medium having computer program instructions stored thereon that are arranged to perform one or more of the above described operations.

These and other aspects of the invention are described further below with reference to the figures.

### BRIEF DESCRIPTION OF THE DRAWINGS

FIG. 1 shows a flow path abstraction, including a source and a destination, for one embodiment.

FIG. 2 shows a path connecting two resources in accordance with one embodiment.

FIG. 3 is a flow chart illustrating a procedure for collecting and analyzing flow data in accordance with a specific embodiment of the present invention.

FIG. 4 is a block diagram of instrumentation for flow data collection in accordance with one example implementation of the present invention.

FIG. 5 is a flow chart illustrating details of multiple flow data processing in accordance with a specific implementation of the present invention.

FIG. 6 is a diagrammatic representation of an example flow map in accordance with one embodiment of the present invention.

FIG. 7 a is a screen shot from a user interface (UI) including a heat map in accordance with a specific embodiment.

FIG. 8 is diagrammatic representation of an example system that can provide flow characterization and resource management for customer cloud resources in accordance with one embodiment.

FIG. 9 is a diagrammatic representation of a system providing cloud resource management in accordance with one embodiment.

FIG. 10 illustrates a method for interactively managing bottlenecks in accordance with one embodiment of the present invention.

FIG. 11 shows a flow map, including nodes and flows between the nodes, that has been output by the system via a user interface in accordance with one implementation of the present invention.

FIGS. 12A-12B illustrate a detection of bottlenecks from the output port of a virtual machine of the sender to the input port of another virtual machine of the receiver in accordance with one embodiment of the present invention.

FIG. 13A illustrates a process for detecting and locating a bottleneck in a receiver node in accordance with a specific implementation of the present invention.

FIG. 13B illustrates a process for detecting and locating a bottleneck in a sender node in accordance with a specific implementation of the present invention.

FIG. 13C illustrates a process for detecting and locating a bottleneck in the transport layer (or network stack) of the receiver node in accordance with a specific implementation of the present invention.

FIG. 13D illustrates a process for detecting and locating a bottleneck in the transport layer (or network stack) of the sender node in accordance with a specific implementation of the present invention.

FIG. 13E illustrates a process for detecting and locating a bottleneck in the output port of the sender node in accordance with a specific implementation of the present invention.

FIG. 13F illustrates a process for detecting and locating a bottleneck in the virtual network in accordance with a specific implementation of the present invention.

FIG. 14A˜14C include flowcharts illustrating procedures for locating bottlenecks in a system deployed in a cloud or distributed network in accordance with specific embodiments of the present invention.

### DETAILED DESCRIPTION OF THE DESCRIBED EMBODIMENTS

In the following description, numerous specific details are set forth in order to provide a thorough understanding of the present invention. The present invention may be practiced without some or all of these specific details. In other instances, well known component or process operations have not been described in detail to not unnecessarily obscure the present invention. While the invention will be described in conjunction with the specific embodiments, it will be understood that it is not intended to limit the invention to the embodiments.

As described above, in the cloud, applications are deployed over virtual resources that are dynamically provisioned and mapped to a pool of physical servers. While this approach simplifies the server infrastructure set up, the reality of application operations is far more complex. Using this server-centric approach to cloud or distributed provisioning, enterprises that rely on the cloud or distributed computers for demanding, dynamic and mission-critical applications, expose themselves to problems including, 1) unpredictable latencies, 2) lack of visibility into resource interactions, 3) inconsistent and bad user experience, 4) disastrous effects of cascading bottlenecks and 5) wasted capacity due to over-provisioning which drives up costs.

DevOps and IT Ops teams take various approaches to resolve infrastructure problems. For example, the teams may launch multiple resources, and shut down the ones having the highest latencies or that are executing on inappropriate hardware. This approach is manual and time consuming. It leaves no opportunity for dynamic and automatic reconfiguration of the cloud networking to adapt to problems as they arise. Further, this technique involves heterogeneous management tools, many complicated scripts and manual touch points, which have errors of their own, and such errors may exacerbate rather than solve the problems.

As another approach, complicated and numerous dashboards and alarm systems can be used. These dashboards drown a user in raw data and noise and are not intuitive to use. Further, a significant portion of the raw data that is presented is not even useful to characterizing and solving the current problem of interest. Thus, sifting through these alarms and charts and identifying the true actionable information is time consuming and error prone.

In summary, monitoring and troubleshooting applications that have increasingly varying traffic loads across multiple geographies and with complex constraints, based on a “black box network” and multiple management and operations systems, is very challenging. Applications often experience periods of bad performance and downtime, while DevOps teams spend their limited time and resources with hands-on operations to continuously adapt to the changing workloads, instance failures and cloud outages. Therefore, DevOps teams need more network infrastructure automation and programmability, which can be manifested as integrated tools, to overcome these challenges.

Software Defined Networking (SDN) defines a new architecture for the “network machine” and is possibly a step in trying to address these issues. SDN decouples the Network Data plane from its Control plane to enable agile virtual networks. However, as described above and in more detail below, there are a host of issues associated with optimizing application performance in the cloud that SDN does not directly address. Thus, the flexibility provided by SDN alone can't ensure predictable and high application performance cloud networking nor efficient cloud network operations.

As described herein, it is believed that tools for characterizing, abstracting and managing a tight coupling between application, cloud or distributed infrastructure and a virtual or physical network, SDN-based or not, can be used to address and fix the problems associated with optimizing application performance. This approach can be referred to as Application Defined Networking (ADN). ADN provides tools for adapting the network and working around problems automatically, thus maintaining business continuity and optimizing resource utilization. Although the following embodiments are described in the context of virtual networks and cloud environments, embodiments of the present invention may be applied to physical networks, distributed environments, and any other types of environments having an operating system (OS), such as Linux and the like.

ADN tools can characterize cloud operations, present characterization data in a manner that provides an intuitive understanding of current cloud performance issues and then generate an interface for presenting, and implementing intelligent remedial actions for solving performance problems. As an example, using ADN tools, a user can discover and articulate the cloud network topology and the application topology associated with their particular applications. The tools can be configured to detect and locate the bottlenecks and provide options for working around these bottlenecks in real time. The ADN tools can be configured to enable two-way communication of performance and configuration information between applications and the networked infrastructure to allow applications to be adapted to the network and the network to be adapted to the applications in a cohesive manner.

With respect to the following figures, architecture for defining and characterizing network and infrastructure performance in an ADN environment is described. The architecture includes a number of abstractions that are presented for the purposes of illustration only and are not meant to be limiting as different abstractions can be utilized within the architecture. Although not described in detail herein, the characterization metrics derived from the characterization architecture can be presented in an interface that allows a user to manage and optimize their application performance and resource utilization in a cloud environment. In one embodiment, the characterization metrics can be derived from state variables associated with the TCP protocol.

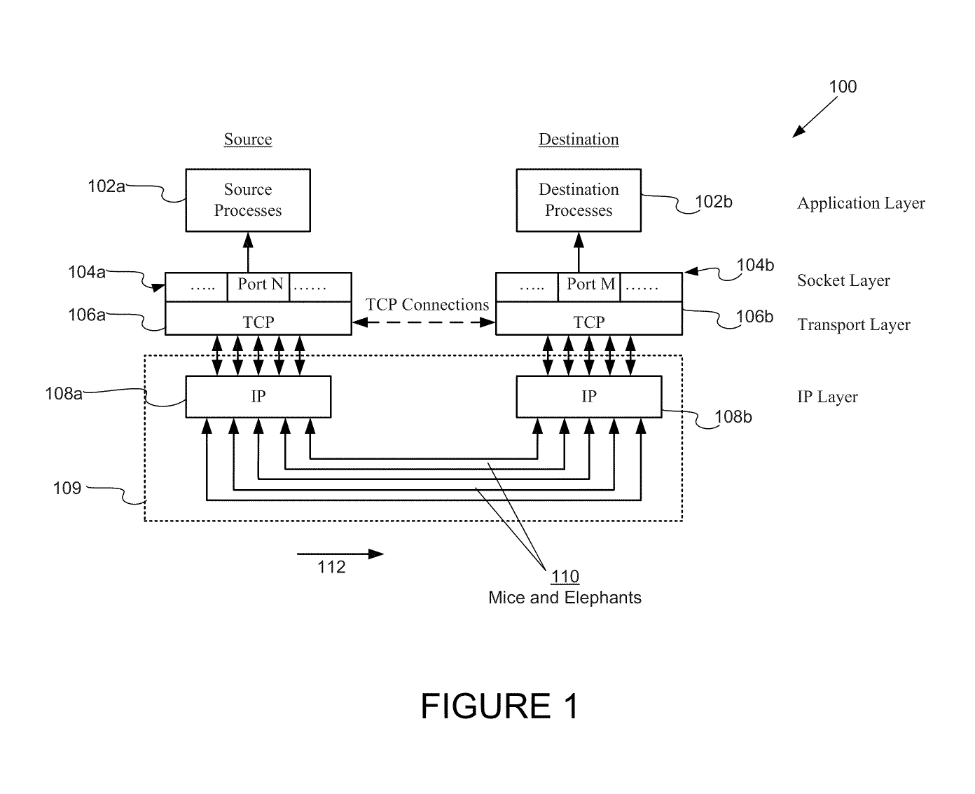

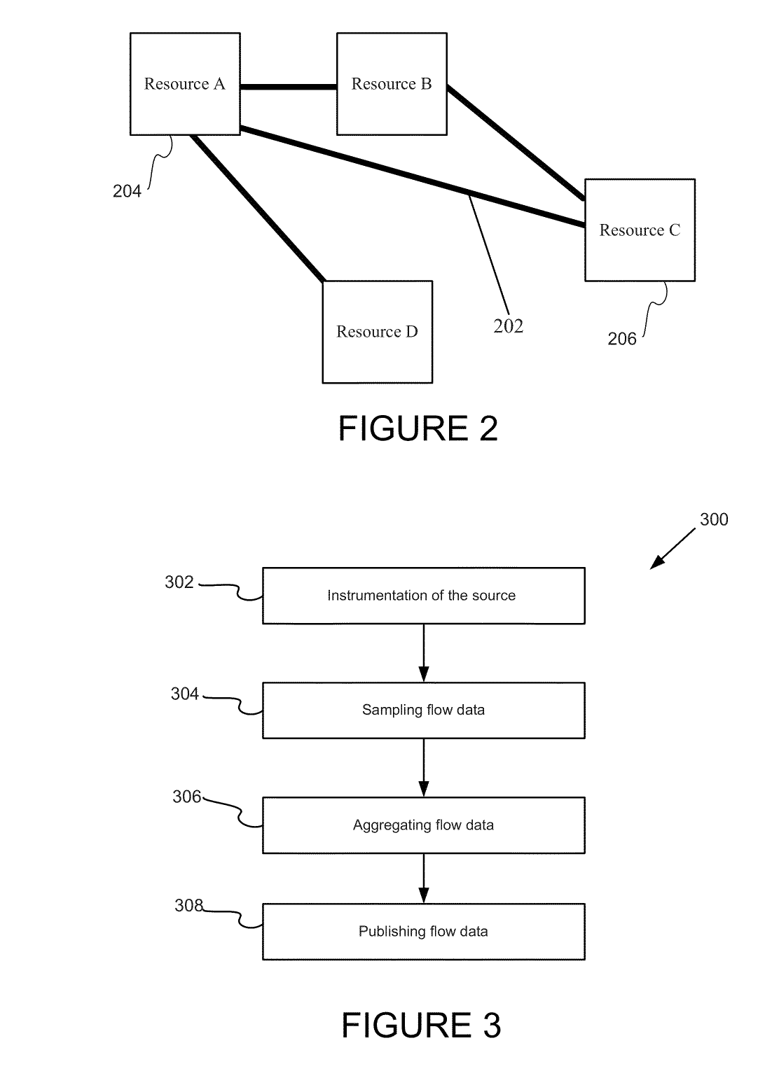

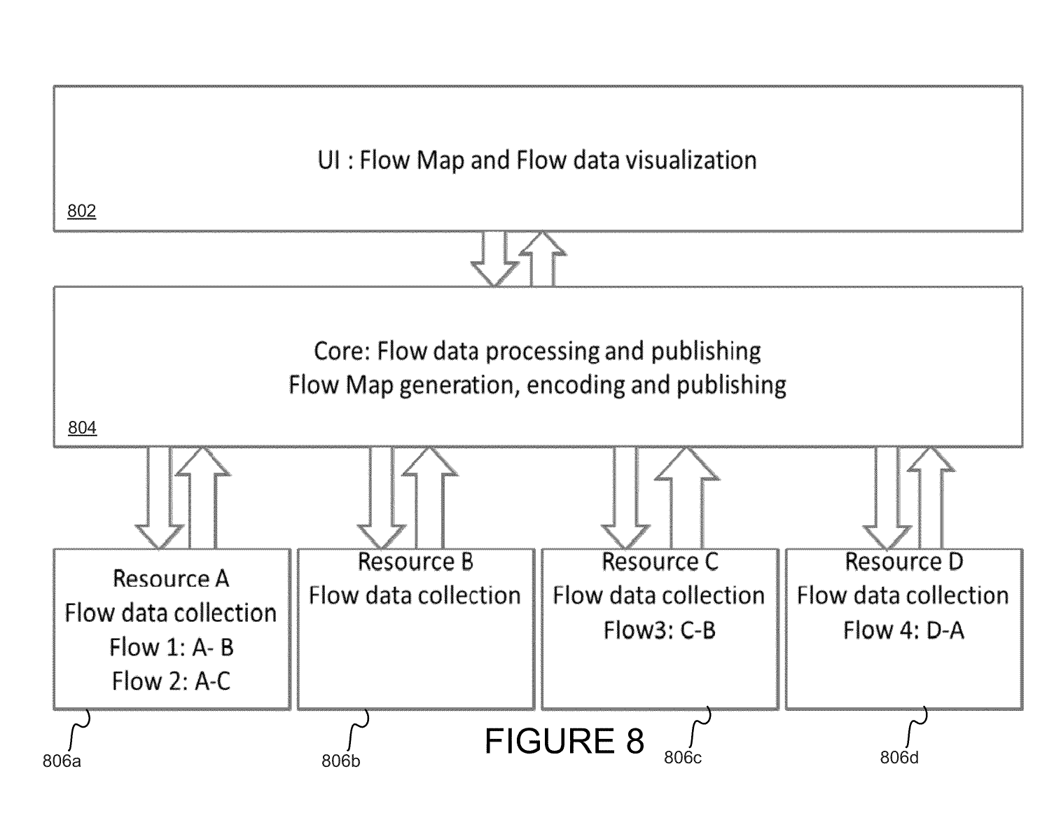

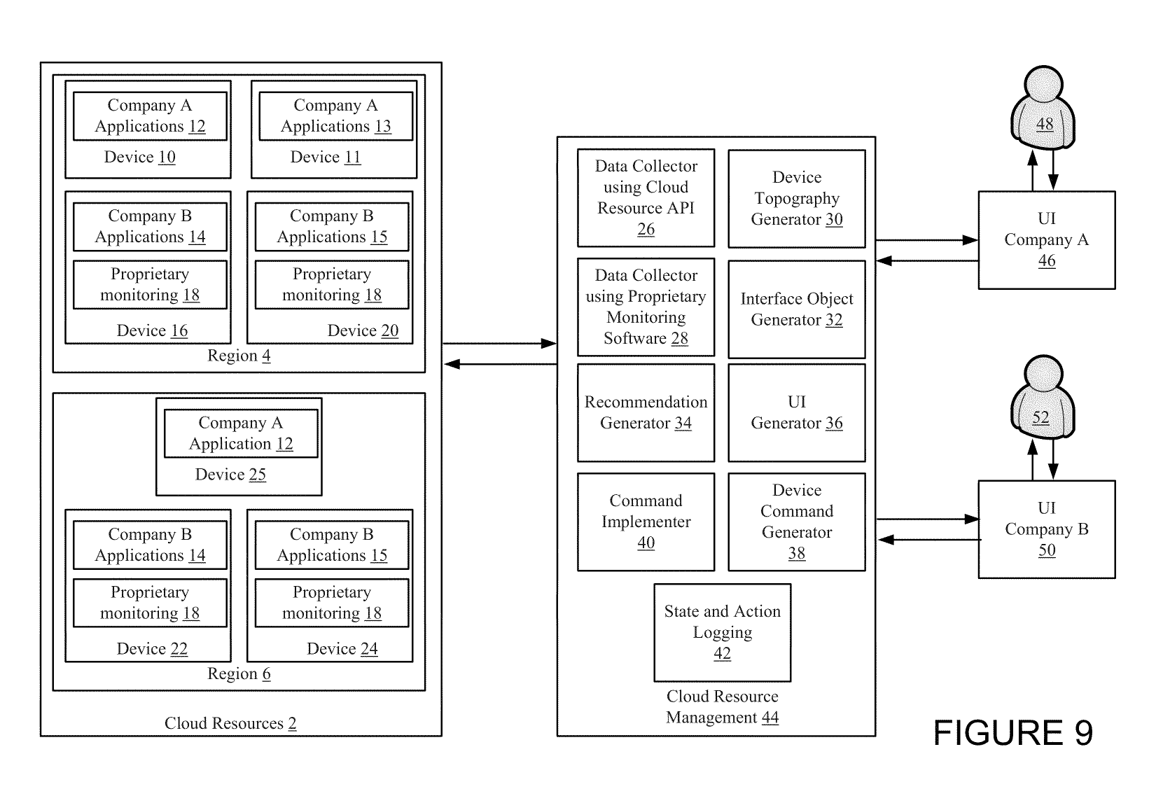

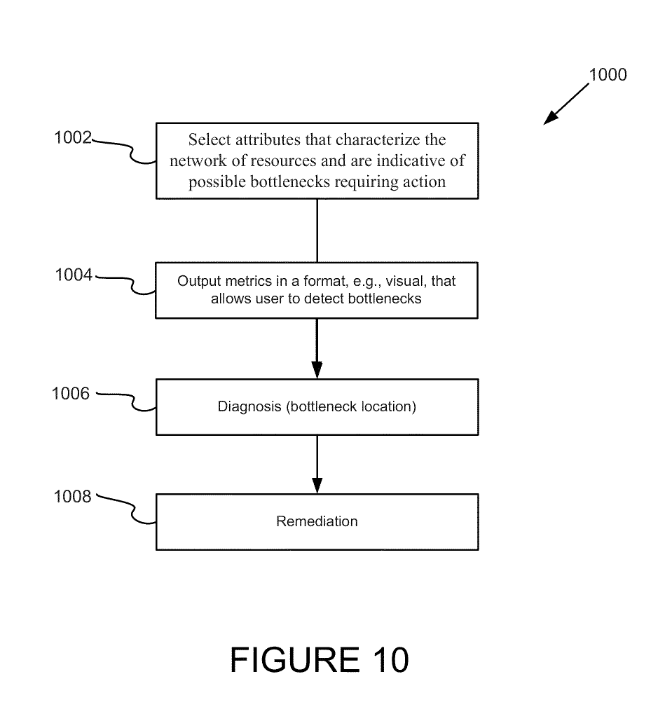

In following sections, system architecture, flow generation, a system overview and methods that can be implemented for monitoring and managing resources are described. The system architecture section, FIGS. 1-2, describes quantities, such as paths and flows, which can be characterized by the system. More details of generating and visualizing the flow are described with respect to FIGS. 3-7 in the flow generation section. A system overview section, FIGS. 8 and 9, includes a description of example components of the system used to implement the system architecture and flow generation. In the last section, the methods for finding and remediating bottlenecks are discussed with FIGS. 10-14E.

### System Architecture

In the cloud, computing and communication resources are dynamically provisioned and managed to implement an application. The cloud includes software or hardware components which process, store or transport data in a cloud. There are resources which can be dynamically provisioned and managed by cloud infrastructure users and other which cannot. A resource can be a virtual machine, a virtual load balancer, a virtual router, a virtual switch or a virtual link. A manageable resource is a resource which can be reconfigured and monitored by a cloud infrastructure user. A provisionable resource is a resource which can be dynamically provisioned and allocated to a specific cloud user for a period of time.

FIG. 1 shows an abstraction of a flow path, including a source and a destination, for one embodiment. Two components of the architecture described herein are a flow and a path. A flow or path can be an abstraction of resources between a source resource and a destination resource used to carry data between two points. In one embodiment, the flow or path starts at the source's socket layer 104a and ends at the destination's socket layer 104b. The illustrated flow moves in direction 112. In a specific example, a source process 102a may initiate a flow in the source socket layer 104a, which transmits through transport layer 106a and then IP layer 108a. A destination IP layer 108b receives data from such source IP layer 108a, which is then received through destination transport layer 106b and destination socket layer 104b, and finally received by a destination process 102b.

A source or a destination of a flow or a path can be any type of logical resource. As described above, a resource is a dynamically provisioned and manageable software or hardware component which has a functional role in an application. For example, the role may be to process, store or transport data in a cloud. In one embodiment, the resource can be a logical entity. For example, it can be a virtual machine, a network service or a storage space. A resource can also be a group of similar resources. In this case, the flow between clustered resources is the aggregation of the individual flows between the clustered resources and the destination resource. This flow is also named a flow group.

The resource can be identified by its universally unique identifier (UUID). A UUID is an identifier standard used in software construction, standardized by the Open Software Foundation as part of the Distributed Computing Environment. The intent of UUIDs is to enable distributed systems to uniquely identify information without significant central coordination.

A resource can implement a transport layer, which multiplexes and demultiplexes data from different connections and communicates with the application processes via sockets. The connections are characterized by IP addresses and ports (e.g., 104a, 104b). As example, the transport layers can be UDP or TCP. In TCP/IP, every accessible server (in this case, virtual machines) has one or more IP addresses and each of those IP addresses has a large range (0-65,535) of “ports” that can be used. Connections to servers can be made based on a combination of IP address plus port. Services running on the server that accept incoming requests designate what IP/port combination they are going to listen to, and only one service can listen to any combination at one time.

A flow can represent the data exchanged between a source and a destination during a period of time. As indicated FIG. 1, a flow starts at the source transport layer 106a and ends at the destination transport layer 106b. As shown in FIG. 1, a flow is an aggregation of microflows (or connections). A flow can be composed by different types of microflows (or connections) 110, referred to as “elephants” (high volume, long duration) or “mice” (small volume, short duration).

As described above, to optimize the implementation of an application in the cloud, metrics that characterize the accessible underlying cloud infrastructure are useful. Metrics which characterize the activity generated by the application on this cloud infrastructure are also useful. The flow represents the activity of the application in the underlying network path. In one embodiment, a flow can be characterized at a minimum by its latency and throughput, which are both functions of time. The latency can be defined as an average time it takes for information to go from a source to a destination and back. The relevant unit of measurement is typically the millisecond. The latency metric can be applied to both flow or path objects. The throughput can be defined as a rate at which information can be reliably sent to a destination. Throughput can be expressed in terms of megabits per second (Mb/s) and it is applicable to characterizing the flow.

Other metrics that can be used to characterize a flow are reliability and the number of connections. The number of connections is the number of connections composing a flow. The reliability metric can relate to packets lost and duplicated over time, a percentage of redundant information that have to be sent to recover these errors and congestion events (timeout) over time.

A path is the abstraction of the sequence of network software and hardware components between a source and a destination used to carry flow data between these two points. A path starts at the transport layer of the source and ends at the transport layer of the destination. FIG. 2 shows a path 202 between two resources 204 and 206, e.g., a source and a destination.

In the embodiments described herein, it can be desirable to characterize a path. As described above, a path is defined by its source and destination. In one embodiment, the path may be characterized by its latency and capacity. The bandwidth capacity of the path is the upper bound of the rate at which information can be sent to a destination. It may happen that a flow using a path exceeds the capacity of the path. In this case there is a congestion event and flow packets can be lost. The location where this congestion occurs is referred to as a bottleneck.

Another example of a metric is congestion level. This metric can be used to evaluate the severity of the congestion of a path. The congestion level can be defined on a 0 to 10 scale. Level 0 is used for a network path that is never congested (which never drops packet because of buffer overflow) while a 10 corresponds to a path blocking or dropping almost all packets for more than 1 hour. The congestion level can be defined by the number of drops and the duration of the event. Congestion can be costly. Some studies give numbers, such as $42K cost for one hour of network outage. Path congestion for one hour is considered as an outage.

The path latency can be defined as the average round trip time experienced by a packet forwarded in the path. The minimum path latency is the lower bound of the path latency observed during a period of time. The latency may be expressed in milliseconds. The latency can be represented as a time function or by its statistics (min, max, mean, standard deviation, 90th percentile, 99th percentile).

The capacity can be considered as an upper bound on the amount of information that can be transmitted, stored, or processed by an allocated resource. The capacity can be represented as a time function or by its statistics. For example, the path capacity is expressed in Mb/s. The path capacity is the sum of the available capacity and utilized capacity.

The latency and capacity of a path can vary over time and are not necessarily accessible directly. In particular embodiments, these characteristics can be estimated by active probing or inferred from transported data. The capacity can be represented as a time function or by its statistics.

As described above, flow or a path can start and end in the transport layer of a resource, where TCP is one example of a transport layer that can be utilized. TCP is a transport protocol which has several functions. One TCP function is to send and receive data from/to the application process. A second function is to control the congestion within the network (specifically on the network path used by the connections). In various embodiments, described herein in more detail as follows, both of the functions and variables associated with these functions (TCP variables) can be utilized. In one embodiment, TCP variables of connections between a source and a destination can be used to estimate the flow patterns as well as to detect congestions within a path.

One of the aspects of optimization and resource management may be related to identifying and responding to communication bottlenecks. A bottleneck is a spot of the infrastructure where the activity is perturbed and slowed down. A bottleneck is a problem in the cloud network that is preventing cloud resources from operating at their full capacity. For example, this could be a slow router creating network congestion or an underpowered computing resource that causes an application to slow down.

The capacity of a path is the sum of utilized capacity and available capacity. The utilized capacity is the consumed amount of information that can be transmitted by unit of time, stored or processed by a utilized allocated resource. For a path, the utilized capacity is expressed in Mb/s. The utilized capacity corresponds to the flow throughput. The available capacity is the remaining amount of information that can be transmitted by unit of time, stored or processed by a utilized allocated resource. For a path, the available capacity is expressed in Mb/s. When the available capacity approaches zero, the flow can be considered bottlenecked. When TCP is utilized, the TCP (or TCP-friendly) connections of the flow will be forced to reduce their throughput and may experience congestion events. The congestion may materialize as packet drops and a decrease of the congestion window of the connections of the source.

### Flow Generation

Next details of flow generation are described. FIG. 3 shows a procedure 300 for collecting and analyzing flow data. Generating a flow may require instrumentation that allows for the sampling of data. In 302, a source of flow data can be instrumented. In 304, flow data can be sampled using the instrumentation. In 306, the flow data can be aggregated to generate one or more flow and path characterization metrics. In 308, the metrics can be published.

For TCP, in 302, instrumentation can involve use of the transmission control block (TCB) in a TCP stack for each TCP connection. A simple definition of a TCP connection is a set of packets between a pair of sockets (Host IP and port pairs). Since the same pair of sockets may be used for multiple connections, the definition of a TCP connection can be more nuanced. TCP uses a special data structure called a transmission control block (TCB) to manage information about each TCP connection.

Before the process of setting up a TCP connection can begin, the devices on each end perform some “prep work”. One of the tasks required to prepare for the connection is to set up the TCB that will be used to hold information about such connection. This set up task can be done right at the very start of the connection establishment process, when each device just transitions out of the CLOSED state.

The TCB contains all the important information about the connection, such as the two socket numbers that identify such connection and pointers to buffers where incoming and outgoing data are held. The TCB is also used to implement the sliding window mechanism. It holds variables that keep track of the number of bytes received and acknowledged, bytes received and not yet acknowledged, current window size and so forth. Of course, each device maintains its own TCB for the connection.

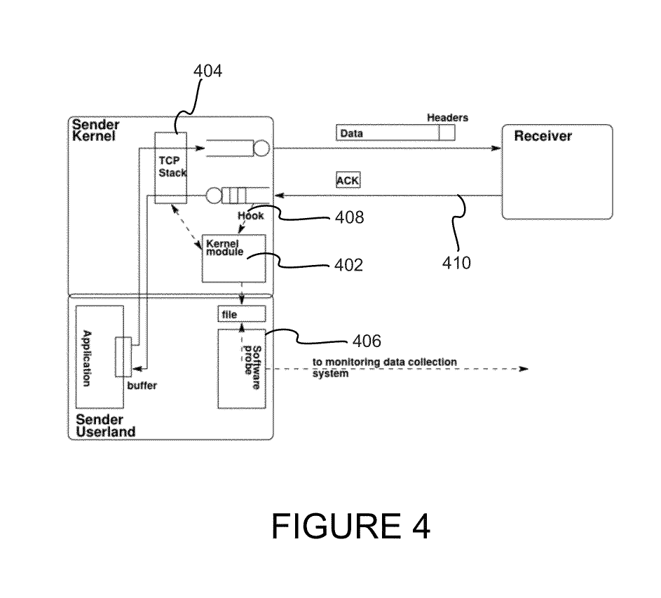

FIG. 4 illustrate the principle of the instrumentation of the TCP stack and the flow data collection for one embodiment. In one embodiment, instrumentation can involve using a modified version of the TCP-probe kernel module (402), which enables access to the TCB of a TCP stack (404). This modification can be used to expose more variables and particularly the variables needed to measure latency, throughput and congestion. In Linux, a TCP probe may be a software module 406 that records the state of a TCP connection in response to incoming packets. It works by inserting a hook (408) into the tcp_recv processing path (410) using kprobe so that the congestion window and sequence number can be captured. For instance, an association between the IP's of the endpoints and the flow's QUID may be maintained since the resource's IP can change, for example, when stopped and started.

In an alternative embodiment, instrumentation of the TCP stack (e.g. Web100, Web10G) may require adding counters throughout the network code of the kernel, which makes it mandatory to have a specific kernel (whole, not just a kernel module) compiled. In yet another embodiment, instrumentation may involve capturing all the packets (e.g. tcpdump, libpcap, specific capturing device) and reconstructing the connections information. In this approach, space, compute time and assumptions on the behavior of the TCP stack in the targeted systems (specific case for the twenty or so configuration parameters of the TCP stack) may be used.

Referring back to operation 304 of FIG. 3, sampling may involve sampling TCP variables that are maintained by TCP. The TCP stack updates the TCP variables when a packet is sent and an acknowledgement is received. The sampling processes can be parameterized. For example, a user may be able to specify a frequency of the sampling and what TCP variables to sample. Further, the user may be able to select a number of samples or a time period used to determine an average quantity based on the sampling. In one embodiment, the sampling can be triggered in response to a reception of an acknowledgement or a modification of a specific TCP variable.

In 306, the collected data can be aggregated to generate one or more flow metrics. Examples of collected data can include but are not limited to 1) CumulSent: last snd_nxt seen over the period, 2) CumulAcked: last snd_una seen over the period, 3) NbAck: the total number of ACKs seen for this connection, 4) NbPackets: the total number of times we have seen the snd_nxt change between two successive ACKs, 5) SRTT: the mean value of the srtt over the period. 6) RTTVAR: the mean value of the rttvar over the period, 7) RTO: the mean value of the rto over the period, 8) LostOut: the max value of lost we have seen over the period, 9) Retrans: last retrans seen over the period, 10) MinInflight: minimum of inflight segments seen over the period, 11) MaxInflight: maximum of inflight segments seen over the period, 12) MinCWND: minimum value of the cwnd seen over the period, 13) MaxCWND: maximum value of the cwnd seen over the period, 14) MinSSTRESH: minimum value of the sstresh seen over the period, 15) MaxSSTRESH: maximum value of the sstresh seen over the period, 16) MinWND: minimum value of the receive window over the period, 17) MaxLength: maximum packet length seen over the period and 18) NbRTO: estimation of the number of RTO events, based on the number of times the frto_counter moved.

In 308, flow data publishing can involve generating reports for each resource. The reports can include time varying data for each of the flow metrics determined in 306. The time varying data can be output in various formats to the users to allow the user to grasp a performance of their application in the cloud.

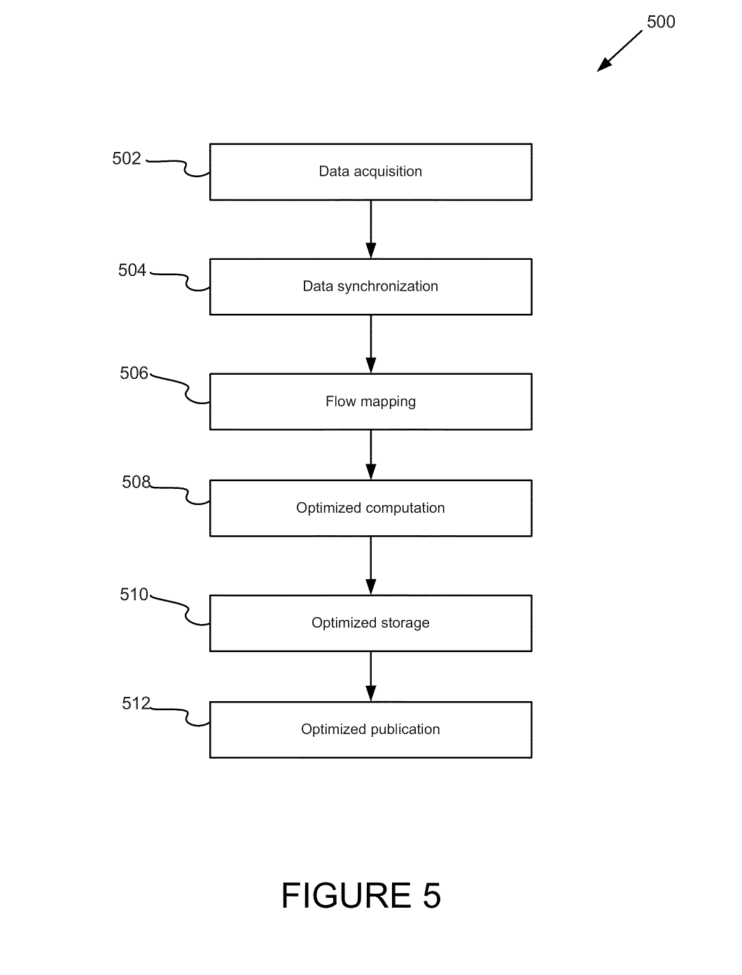

Next details of multiple flow data processing are described with respect to FIG. 5. In operation 502, data acquisition can include collecting in real-time data from multiple resources. These data include flow data as well as virtual resource data. The data may be received asynchronously on a communication bus. Several samples may belong to the same flows and may be grouped by time periods. As described above, the time periods may be a selectable parameter. In operation 504, the acquired data can be resynchronized in a consistent time series. In operation 506, flow mapping can include extracting the IP addresses from the samples, determining the associated virtual machines, and updating the flow information based upon the received samples. In operations 508, 510, and 512, times series representing metrics of a given flow can be processed for real-time analysis, statistics computations, compressed storage, and real-time publication.

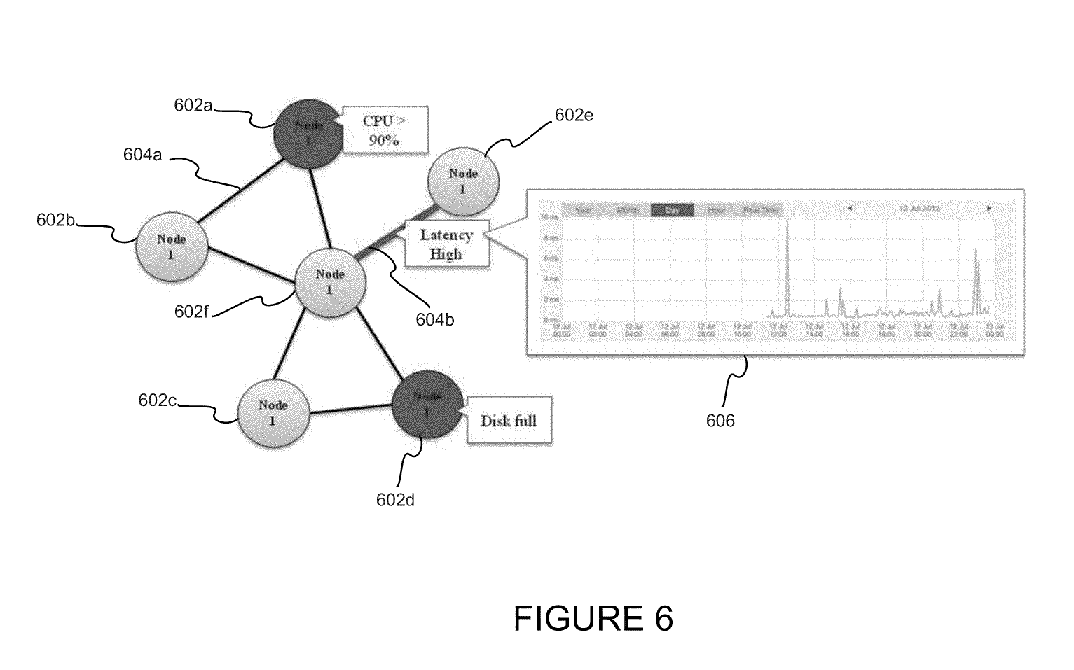

Once the flows are characterized, a flow map can be generated to visually represent properties of the flow. The visual representation can be geared toward providing information that aids in managing the cloud resources. In one embodiment as shown below in FIG. 6, a flow map can be generated to display congestion or bottleneck events. The flow map includes 6 nodes (e.g., 602a-602f) and 7 flows (e.g., 604a and 604b). Two nodes (602a and 602d) and one flow (604b) are high-lighted because of resource issues. Node 602a has a CPU usage greater than 90%. A second node 602d has a disk near capacity. The flow 604b is identified as having a high latency. A resource graph 606 associated with the latency may be displayed to provide additional insight into the latency issue.

In general, the flow map can be configured to display the application graph with flows between nodes. The flows can represent the usage of the network from one virtual resource to another. A flow list generated by a system component, such as the UI (see FIG. 9, UI generator 36) can display the activity and corresponding health (time-series (charts) and statistics with user-defined alert thresholds) of each flow. A node list generated by the system can display activity and corresponding health (time-series (charts) and statistics with user-defined alert thresholds) of each node.

A flow map represents a particular grouping of resources and the connections between the resources. In particular embodiments, the connections can be associated to exactly one flow to make sure there is no double-counting. The rules to create flows can be defined using any characteristics associated to connections. The default partitioning may be done using the source and destination IPs of the connections. If connections are not covered by any flows, a warning can be issued to make the user reconsider its partition scheme.

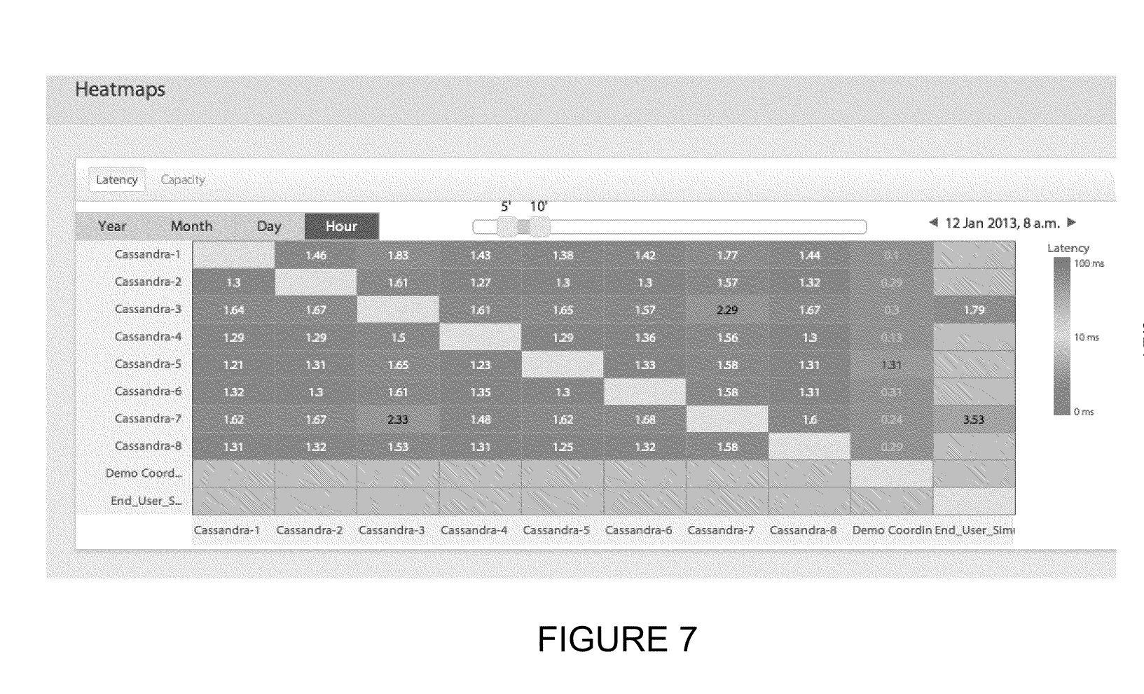

In other embodiments, along with the flow map, the system can generate snap shots and heat maps. A snap shot can display quantities, such as top utilized resources (hotspots & potential bottlenecks), top flows (max throughput, max activity) and top flow latency (highest latency). The flows can be sorted according to these different parameters. A heat map can prove a representation of network performance, where the individual values (latency & available capacity) of the network path matrix are represented by gradual colors. In this matrix, the row and lines corresponding to path with activity, the flow statistics are represented. In the example of FIG. 7, each cell is active, such that a selection of the cell redirects the user to detailed performance information. After selection, the detailed information can be displayed in a pop up window or the system can generate another page that displays the information.

### System Overview

In this section, an overview of a system providing tools that allow a user to manage their cloud resource is described. For illustrative purposes, an example topology of customer's resources in the cloud and management of these cloud resources is first described with respect to FIG. 8. Then, a system for implementing the resource management strategy described in FIG. 8 is discussed with respect to FIG. 9.

Referring back to the example of FIG. 2, four resources A˜D associated with a user's applications executing in the cloud are shown. In FIG. 8, four flows (Flows 1 and 2 of 806a, Flow 3 of 806c, and Flow 4 of 806d)) have been mapped to the resources in FIG. 2. The resources and the associated flows may have been automatically discovered by the system. For instance, a user may have provided access credentials to the system that enable the system to discover the user's current usage of cloud resources. UI flows, as in the flow map, can be made of potentially two flows at the monitoring layer, one for each direction. FIG. 7 shows the metrics of the flow for each direction.

With respect to FIG. 8, resource topologies with more or less flows and more or less resources are possible. Further, different flow mappings between resources A, B, C and D including more or less flows is possible. In addition, the number of flows and the number of resources for a particular user can change over time. For example, at a first time the user may utilize four resources, at a second time a user may utilize three resources, and at a third time a user may use six resources. From time to time, some of the flows may remain constant, new flows may be added or existing flows and/or resources may be terminated. Thus, the number of flows and their associated sources and destinations is provided for the purposes of illustration only and is not meant to be limiting.

Returning to the example in FIG. 8, resource A can collect flow data for a first flow between resource A and B and a second flow between A and C as shown by 806a. Resource C can collect flow data for a third flow between C and B as shown in 806c. Resource D can collect flow data for a fourth flow between D and A as shown in 806d. Resource B may have the ability to collect flow data but, in this example, the collected data is not associated with any flows (806b). To enable the data collection measurement, software may have been previously downloaded to the resources.

The measurement software on each of the resources can acquire data and send the acquired data to a core 804 for processing. The data acquisition can be an ongoing process, where the measurement software is acquiring at different times. The data acquired over time can be used to characterize resource performance over time. In one embodiment, the measurement software on each resource may acquire data in an asynchronous manner from one another. Thus, the core can be configured to perform operations that involve synchronizing the data received from each of the resources, such that it can be output in a time consistent manner.

Besides processing the data acquired from the resources, the core can be configured to automatically discover the resources for a user, such as resources A, B, C and D, generate a topology of the resources, deploy instrumentation to collect flow data, determine the flows between the resources, process the acquired data to generate path and flow characterization metrics, publish results, and process the flows to generate a network graph of flows. In one embodiment, the results can be published via a UI 802 that provides flow maps and flow data visualization for the various discovered resources. Further, the UI can be used to perform actions that affect the resources.

With respect to FIG. 8, a system configured to perform some of the core and UI functions is described. In FIG. 9, for the purposes of illustration, an example configuration involving resource performance visualization and management for two different companies, company A and company B is discussed. Company A and company B utilize cloud resources 2. Company A and company B may each have a distinct set of customers that utilize the applications provided by each company. Company A and company B are typically unaware of each other's resource utilization in the cloud.

The cloud resources 2 are distributed in two different regions, region 4 and region 6. Typically, regions refer to separate geographic locations, such as resources located in the eastern United States and the western United States or resources located in United States and Europe. The resources are distributed to serve users of the applications in a particular geographic area. The allocation of resources in relation to demand in a particular area affects application performance. Thus, the assessment and visualization of the performance of cloud resources according to region can be important.

In the example of FIG. 9, a first set of applications 12 associated with company A are executing on device 10 in region 4, a second set of applications 13 associated with company A are executing on device 12 in region 4 and a second instantiation of the first set of applications 12 associated with company A are executing on device 25 in region 6. Further, a first set of applications 14 associated with company B are executing on device 16 in region 4, a second set of applications 15 associated with company B are executing on device 20 in region 4, a second instantiation of the first set of applications 14 associated with company B are executing on device 22 in region 6 and a second instantiation of the second set of applications 15 associated with company B are executing on device 24 in region 6. As described above, the devices can refer to logical entities. For example, device 10 can be a single virtual machine or a cluster of virtual machines. In addition, a set of applications executing on a device can include multiple instantiations of one or more applications within the set where the number of instantiations within the set can change over time.

The different sets of applications can communicate with one another to complete a task. For example, the first set of applications 12 for company A on devices 10 and 25 may each communicate with the second set of applications 13 on device 11. As another example, the first instantiation of the first set of applications 14 associated with company B on device 16 can communicate with the first instantiation of the second set of applications 15 associated with company B on device 20 to complete a task. In addition, the second instantiation of the first set of applications 14 associated with company B on device 22 in region 6 can communicate with one or both of the first instantiation of the second set of applications 15 on device 20 in region 4 or the second instantiation of the second set of applications 15 on device 24 in region 6 to complete a task.

In one embodiment, proprietary monitoring software can be deployed. However, its deployment is optional. The proprietary monitoring software can be executed in conjunction with the applications to provide additional measurements that can be used to characterize application performance in the cloud. However, even without the deployment of the software, some useful performance measurements may be obtained using functions that are native to the cloud resource, such as functions available via a cloud resource API (Application Program Interface) or a Network monitoring API. Thus, embodiments with and without the proprietary monitoring software are possible. In the example of FIG. 9, additional monitoring software 18 has been deployed for the applications executed by company B but not for the applications executed by company A.

The applications, the devices on which they execute and the communication patterns form a topology in cloud. The topology may involve two layers of abstraction. At a higher level, the network topology can be presented as virtual devices and virtual communication paths. At a lower level, the virtual devices and virtual communication paths can be mapped to actual physical devices and physical communication paths. Thus, a mapping exists which translates the virtual representation of the devices and paths at the higher level to the lower level including physical devices and paths.

In a cloud environment to allow for the most efficient use of resources, cloud resource providers do not provide users with a fixed set of physical resources. Instead, the users are provided with access to some amount of physical resources. However, the physical resources that are provided to each user at a particular time can vary. The abstraction from higher level virtual entities to lower level physical entities helps to enable providing cloud resources as part of a “fee for service” model because it allows some of the physical aspects associated with providing the resources to be hidden from the user.

A very simple analogy is purchasing power. Users of a power grid can agree to purchase a certain amount of power and are provided access to the power. The power can be generated by different power plants at different times, and the user has no control from which power plants they receive power. In addition, the power can be routed by different paths to the user over the electricity grid. Again, the user has no control over how power is routed on the grid. Generally, as long as the user of the power receives reliable power, the user does not care where or how the power is delivered to them.

In traditional networking, to use the analogy above, users often had control of and were responsible for upkeep of the power plants (e.g., servers) and a portion of the electricity grid (e.g., local communications within or between servers). In a cloud environment, this paradigm has changed which provides some advantages but also introduces some new complexities. One such complexity is that unlike power consumption, cloud resource providers have not reached the point where they can reliably provide a guaranteed level of performance under varying demand levels to all of their customers.

If there was sufficient excess computational, memory, and network capacity in the cloud and the cost was low, then cloud resource management would not be such an issue. However, currently, this is not the case in the cloud environment. Thus, tools are needed that help users manage their resource consumption and utilization to respond to changes in the cloud environment that affect the performance of the user's application. If power delivery were less reliable, then one would expect to have tools in the power industry to help users manage their power consumption in a similar manner.

As described in more detail as follows, the system can be configured to discover different sets of applications executing in the cloud including patterns of inter-device communication that the applications utilize, generate metrics as a function of time that characterize that resource performance including inter-device communication, and abstract a topology. The performance information can be mapped to the abstracted topology. The topology and its associated information can be presented in a user interface (UI). Besides the topology, the UI can provide a number of different services for managing the discovered cloud resources in real-time. The topology is abstracted and visually formatted in the UI to present information in a manner that makes managing the cloud resources simple and intuitive. The topology is also encoded in an XML format so that the user can access in an online or offline manner VXDL is an example of a virtual network description language that can be expressed in XML.

In FIG. 9, the cloud resource management 44 is configured to provide the functions described in the previous paragraph. Cloud resource management 44 communicates with the cloud resources 2 and generates user interfaces for managing the cloud resources. In this example, the cloud resource management 44 is shown generating two UI's simultaneously, a first one 46 for company A and a second one 50 for company B. The UI's can receive inputs that trigger actions by the cloud resource management 44, such as inputs from user 48 and user 52. The UI's can be presented remotely on company controlled devices.

The cloud resource management 44 can be implemented on one or more electronic devices including processors, memory and network interfaces. Some examples of the functions that can be provided by the cloud resource management 44 are as described as follows. Data collector 26 uses native cloud functions, such as a cloud resource API, to collects data for a resource topography map that can be output in a UI. It can automatically discover a company's resources in the cloud. This function does not require proprietary software deployed to and running on cloud devices. However, if the proprietary software is deployed, data acquired from 26 and the proprietary software can be combined in some manner and then output to a UI.

Data collector 28 receives data from proprietary monitoring software executing in the cloud. In one embodiment, the received data can be used to generate paths and flows that are output to the UI or to an API. Device topography generator 30 generates a device topography map with or without flows depending on the data collected. Different topography abstractions are possible. Thus, the device topography generator 30 can be configured to generate one or more different topography maps, depending on the abstraction that is utilized. In one embodiment, the UI may allow a user to select from among group of different topography abstractions one or more maps to be presented in the UI.

The interface object generator 32 generates and formats data for presentation to the user in a UI. For example, in one embodiment, the interface object generator 32 may generate flow and path objects that are used in a device topology map or an abstract flow map. The recommendation generator 34 can be configured to analyze data acquired from the cloud resource and determine actions that may improve the performance of the applications executing in the cloud. The actions can be presented as recommendations in the UIs, such as 46 and 50, where the UI provides mechanisms for allowing a user, such as 48 or 52, to indicate they wish to implement the recommendation. The UI Generator 36 generates and controls a UI that can include recommendations, topography map, and interface objects for each user (e.g., company A and company B). The execution of the recommended workflow of actions can also be automated after some machine learning mechanism has captured the optimal remediation and typical choice of a user in a given scenario.

The device command generator 38 can be configured to generate commands for actions triggered via the UI. Actions in the UI can be presented in a high-level format. For example, a user may indicate they wish to move an execution of an application from a first virtual machine to a second virtual machine by dragging a symbol associated with the application from the first virtual machine and placing it in the second virtual machine using a cursor or some other control mechanism. In response to this action, the device command generator 38 can generate a sequence of low-level commands to implement the action on the two devices. For instance, commands can be generated by the UI that cause the first virtual machine to shut down a resource running application and cause a new instantiation of the resource with the application running to be generated on the second virtual machine. The action can also involve moving the entire virtual machine from one network to one another with less congestion.

The command implementer 40 communicates with specific devices to implement commands determined from the device command generator 38. The command implementer 40 can be configured to communicate with the affected resources and keep track of whether the action has been successfully completed or not. The state and action logging 42 can be configured to log actions that are implemented, such as actions triggered from inputs received via the UI. Further, the state and action logging 42 can be configured to saves snap shots of a topology maps showing a state of user resources at various times. For example, the snap shots can be taken before and after a user implements one or more actions via the UI. Then, the snap shots can be shown side by side in the interface to allow the user to visually assess whether the actions had their intended effect. The evolution of the infrastructure state associated to the sequence of actions that are selected to improve the performance can be captured and encoded to reinforce the machine learning system. A model based on a dynamic graph can be used. The main attributes of this graph can be encoded in a computing language so an application can program its adaptation to the infrastructure in advance and the actions be executed automatically when conditions appear.

The various aspects, embodiments, implementations or features of the described embodiments can be used separately or in any combination. Various aspects of the described embodiments can be implemented by software, hardware, or a combination of hardware and software. The computer readable medium, on which software for implementing various embodiments may be stored, may be any data storage device that can store data which can thereafter be read by a computer system. Examples of the computer readable medium include read-only memory, random-access memory, CD-ROMs, DVDs, flash memory, memory sticks, magnetic tape, and optical data storage devices. The computer readable medium can also be distributed over network-coupled computer systems so that the computer readable code is stored and executed in a distributed fashion.

### Methods for Finding and Remediating Bottlenecks

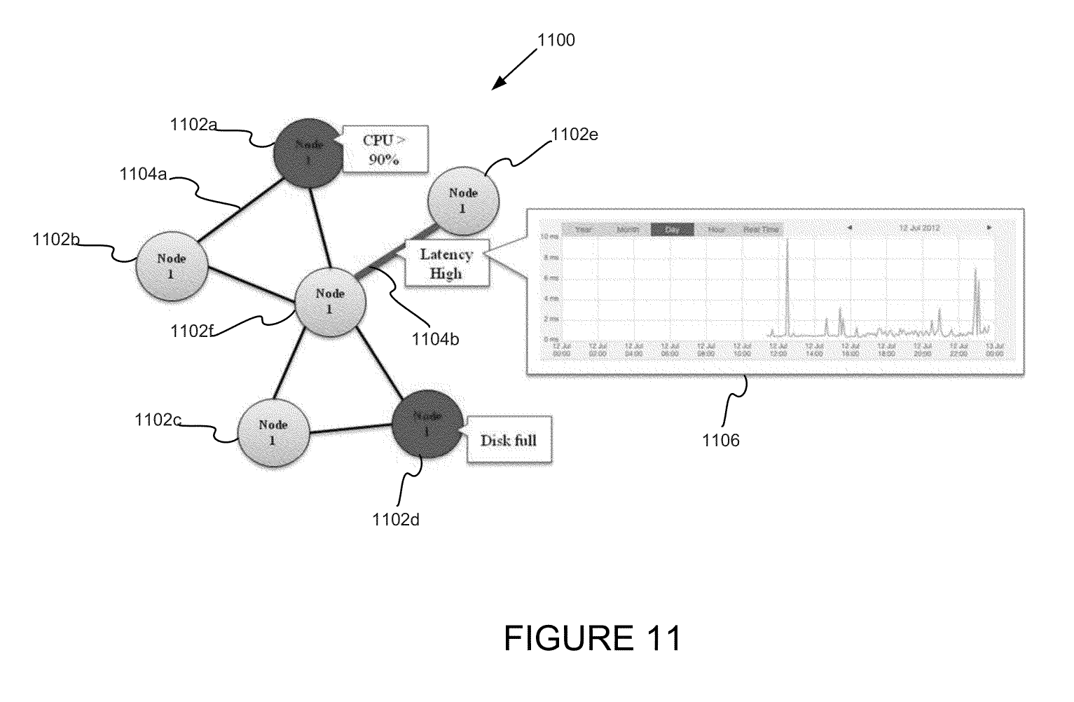

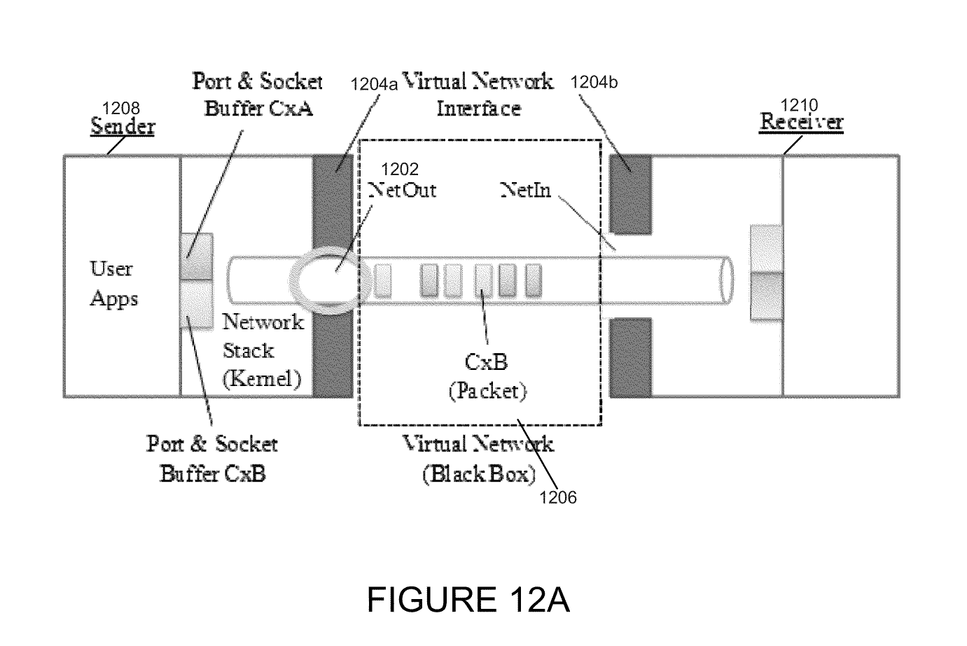

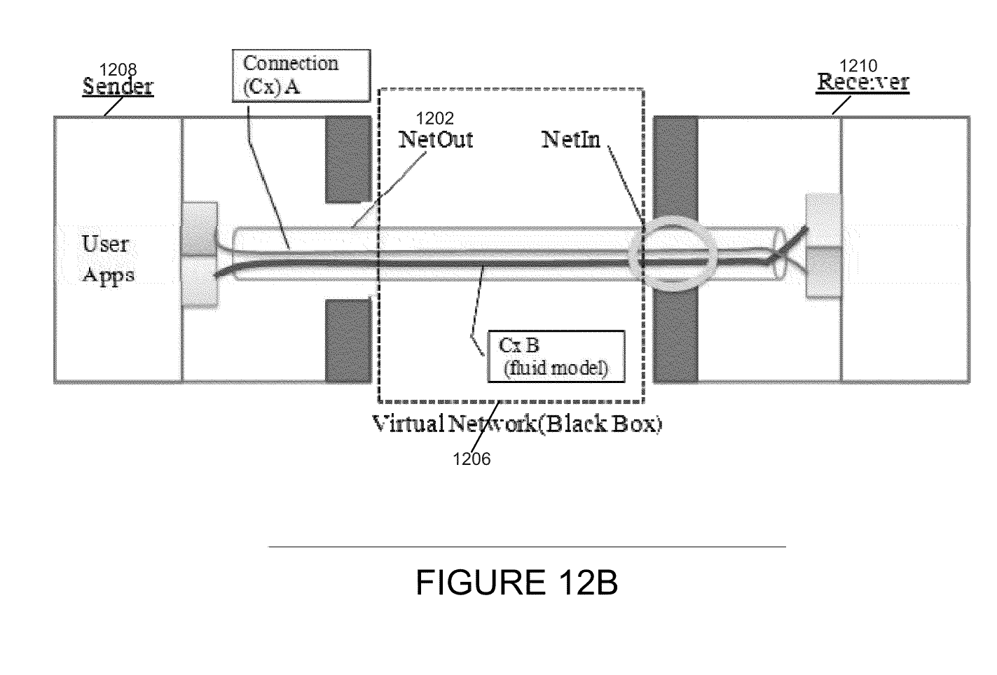

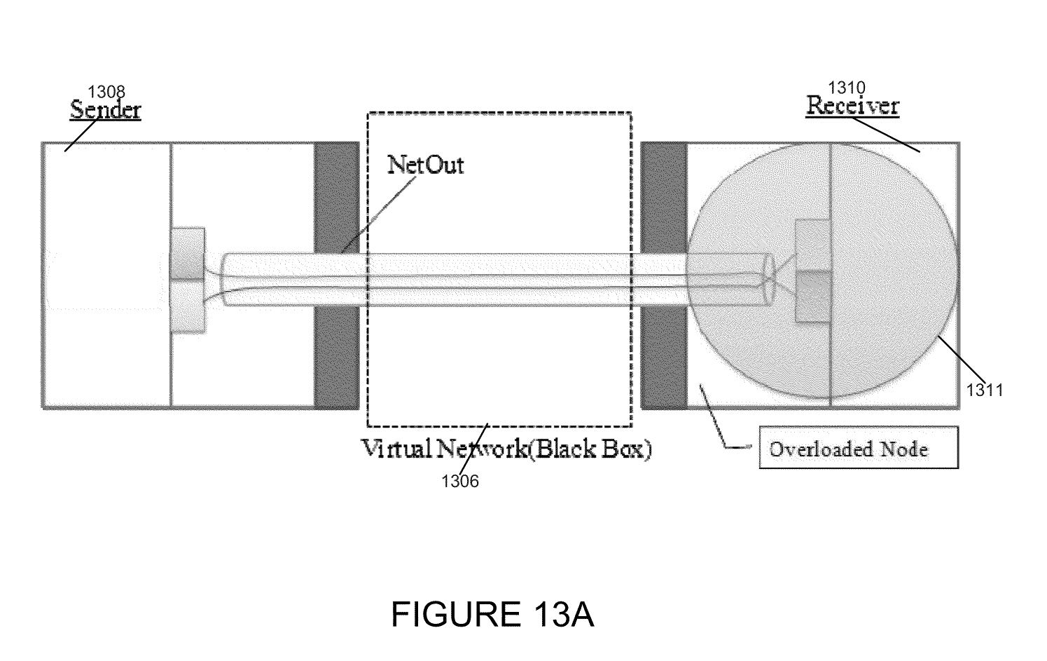

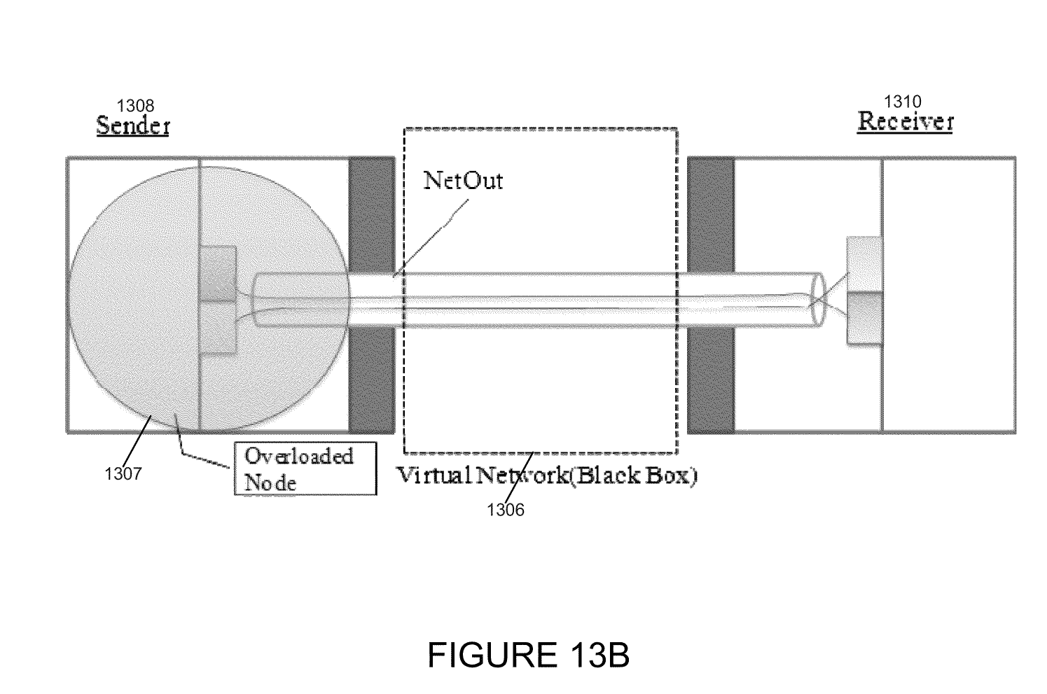

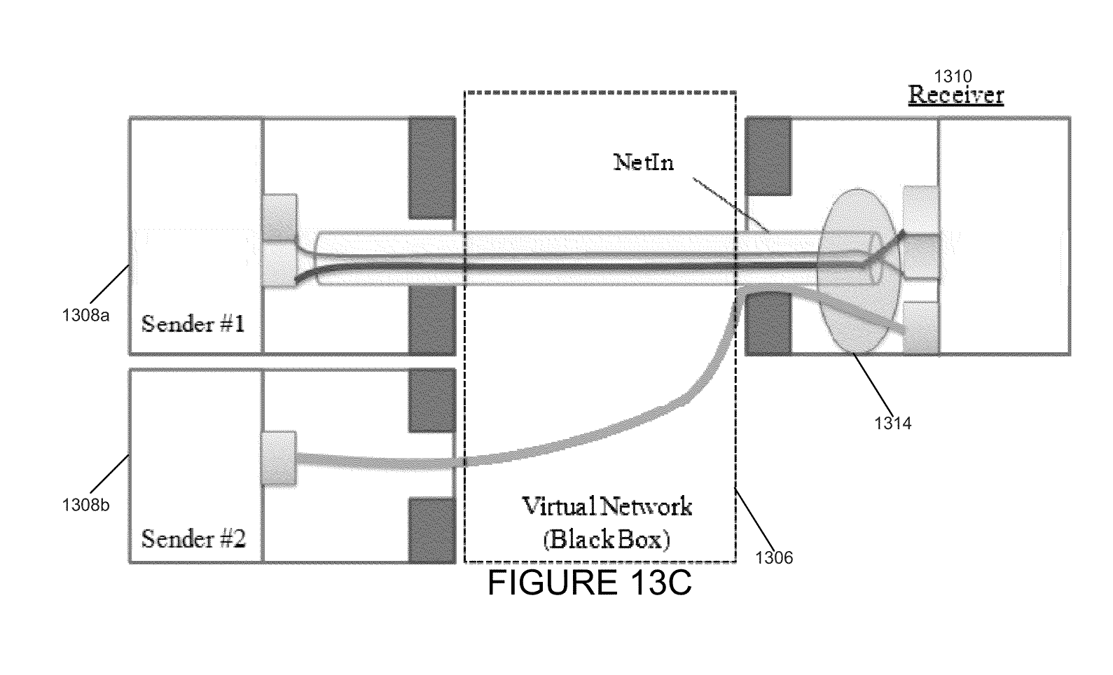

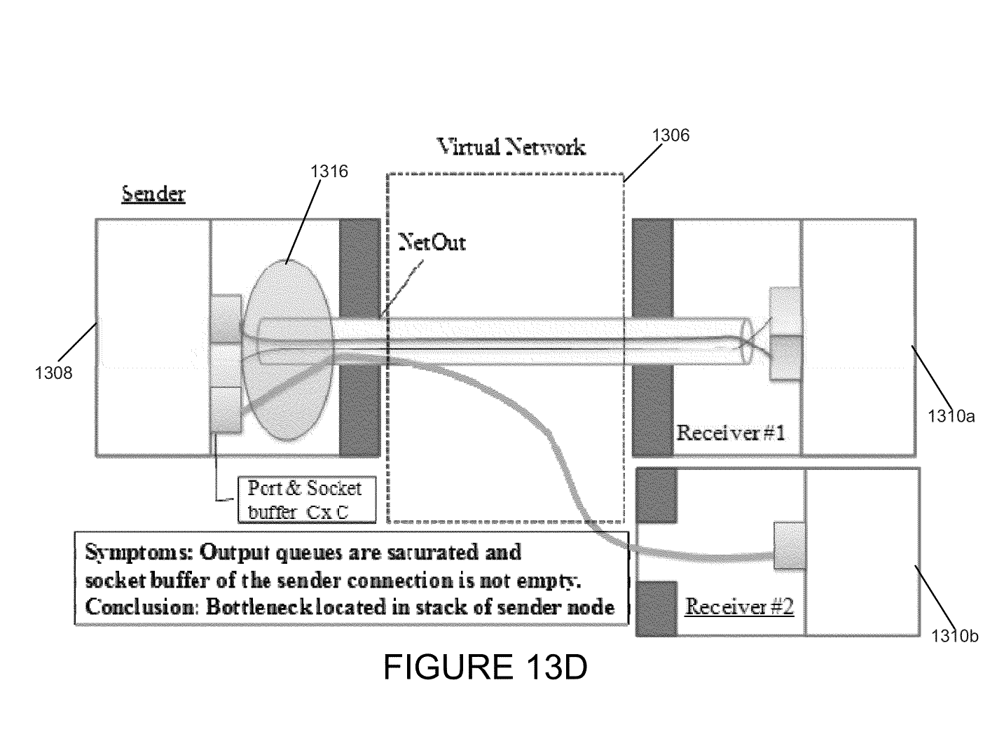

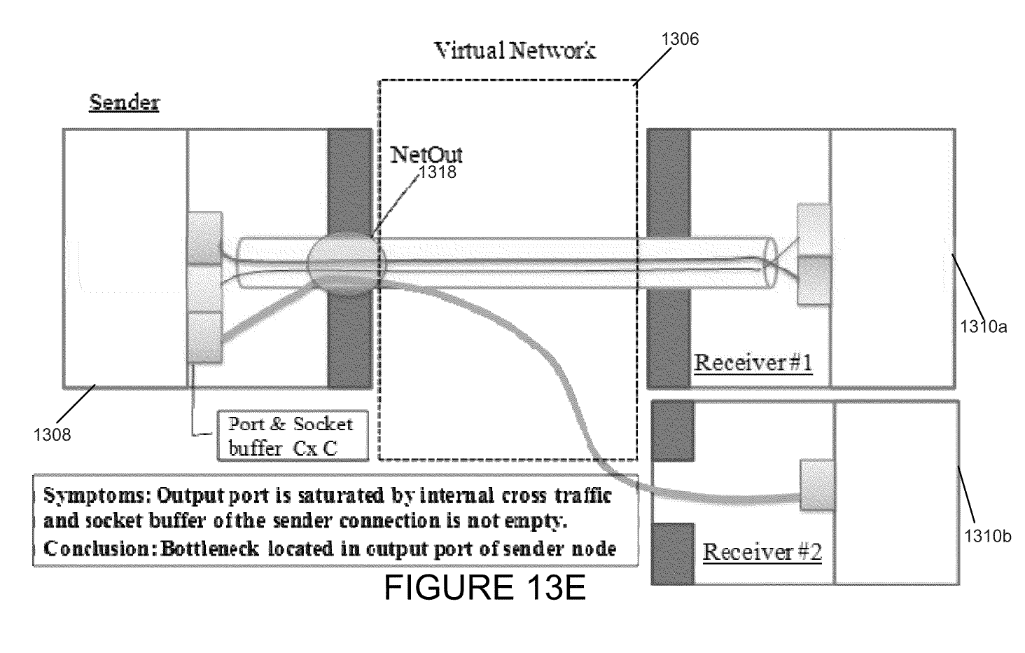

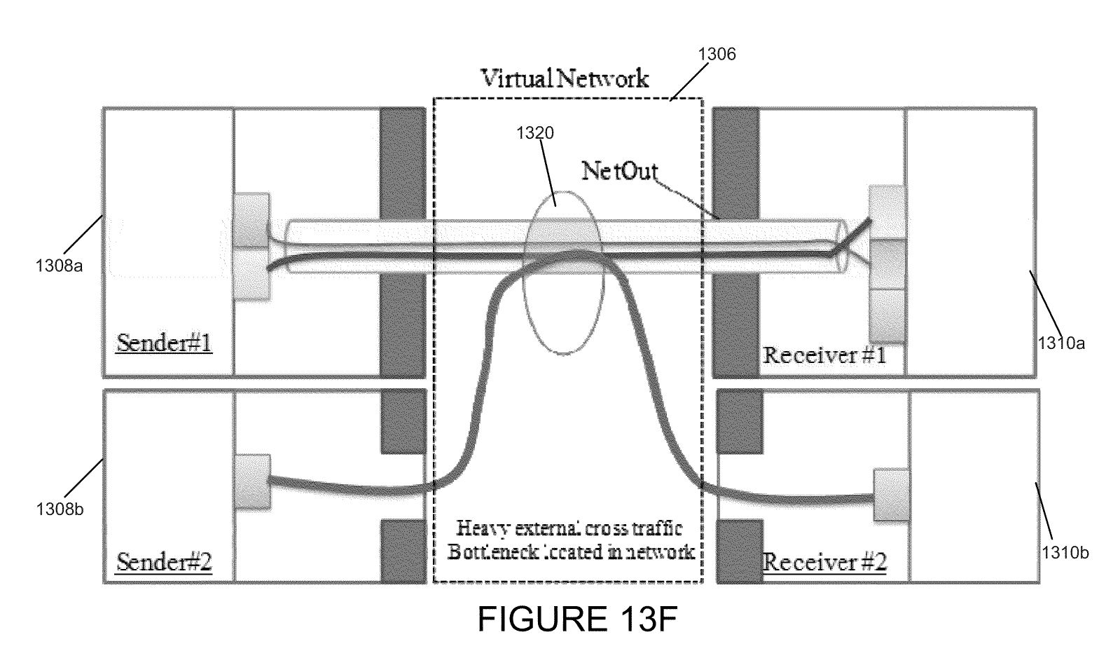

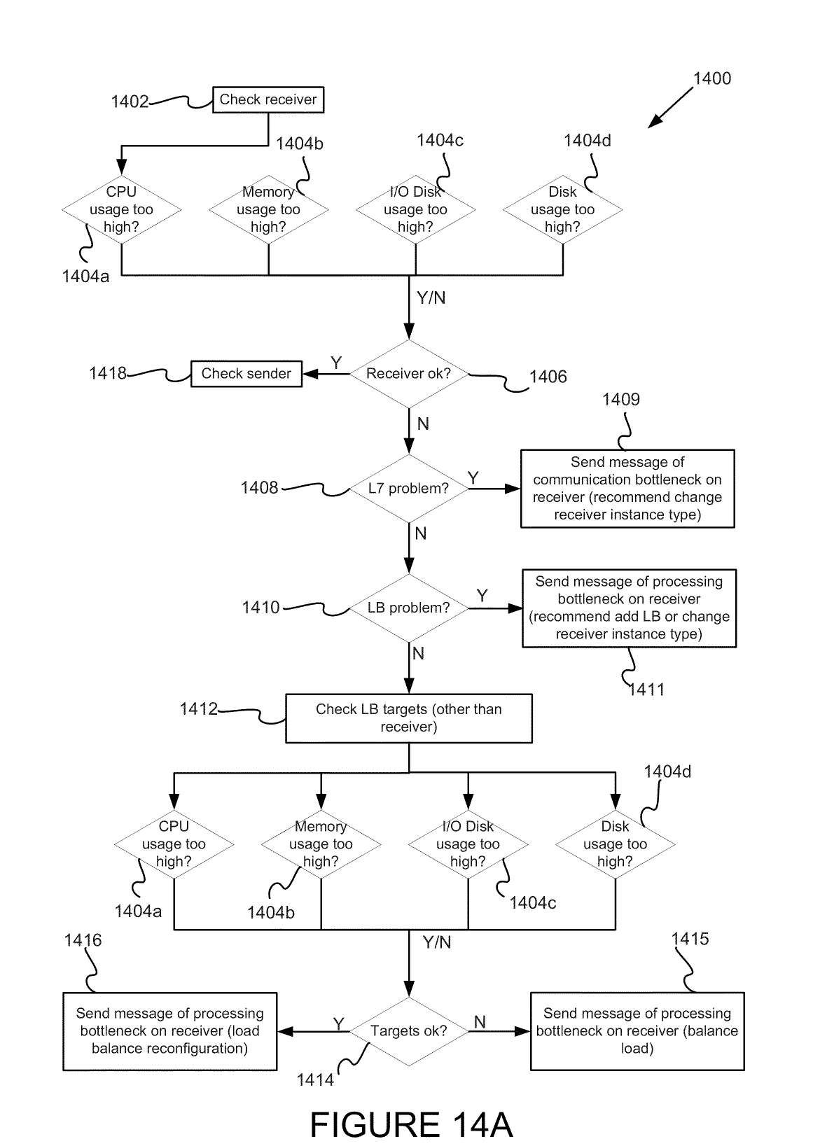

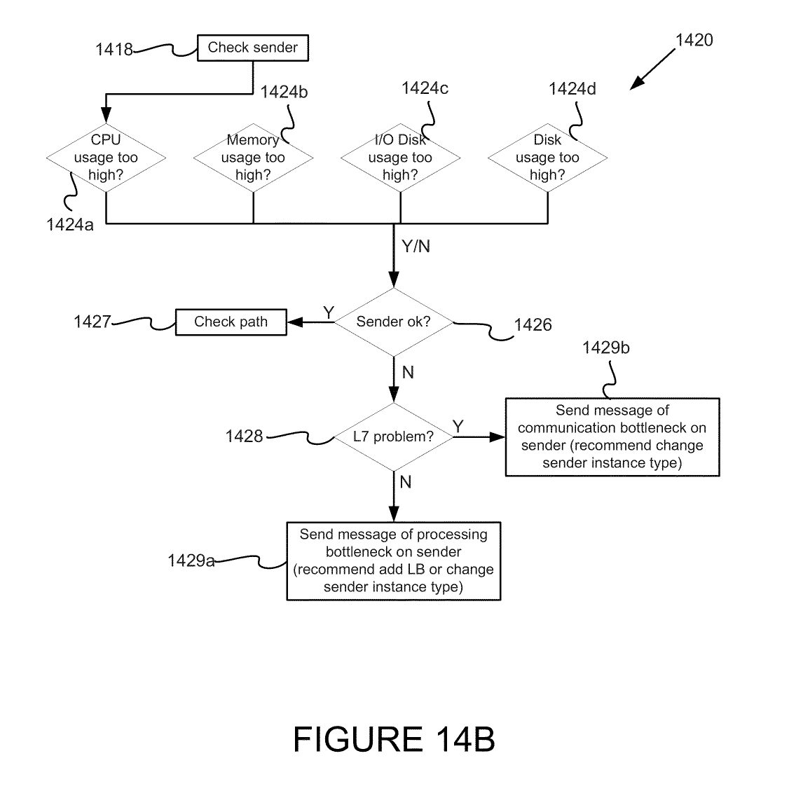

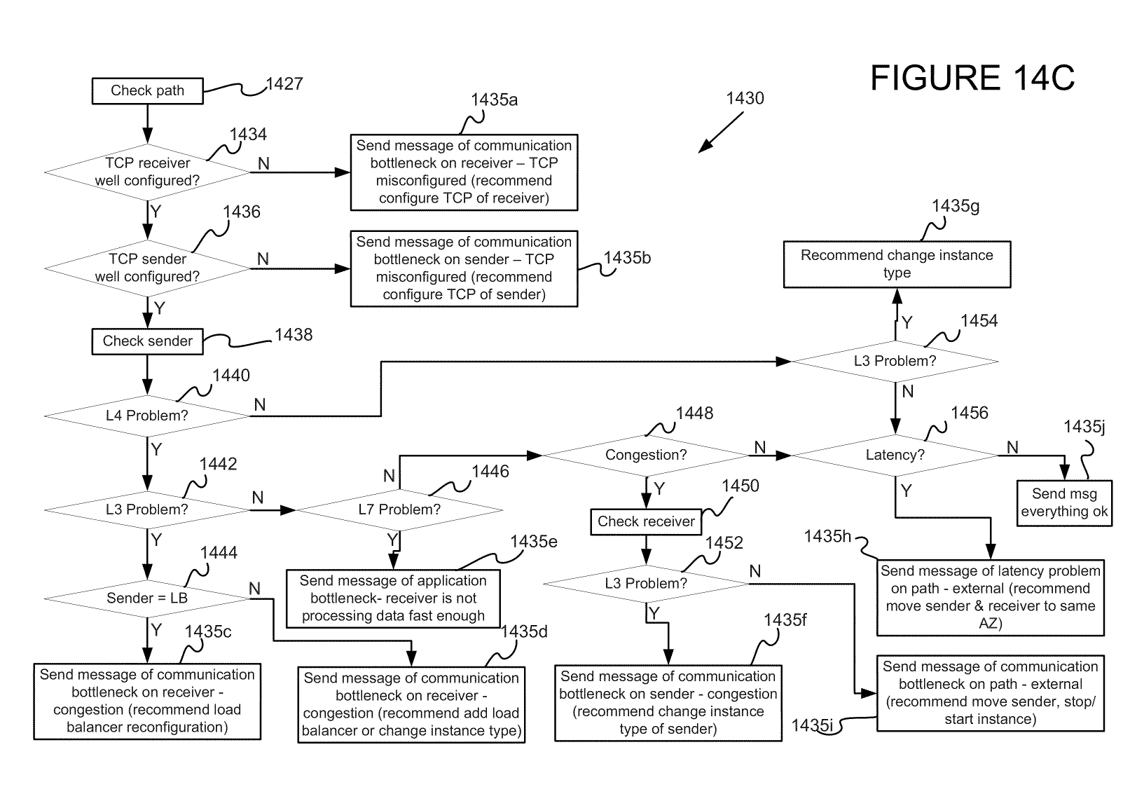

In this section, methods for finding and remediating bottlenecks are described. First, the methodology at a high-level is described with respect to FIGS. 10 and 11. Then, details of examples of detecting and then finding a bottleneck are described with respect to FIGS. 12A, 12B, 13A, 13B, 13C, 13D, 13E and 13F. Finally, a flow chart of a method for finding and remediating a bottleneck is described with respect to FIGS. 14A, 14B, and 14C.

A typical goal of a Development and Operations (DevOps) team is to find an optimal tradeoff between infrastructure cost and application performance. In a cloud (or distributed) environment, costs can be linked to rented capacities and to the utilization of resources by the user's applications. The performance of applications in the cloud can be a function of each applications architecture (e.g., well coded or not), resources dedicated to the applications, the utilization of the resources by the application, and a demand on the applications from users. The resources dedicated to the applications, the utilization of the resources by the application, and a demand on the applications from users can vary as a function of time. Typically, a DevOps team is trying to provide satisfactory performance to their users at all times while minimizing the cost of the resources necessary to provide the performance.

Bottlenecks in a cloud user's system can cause purchased resources to be used inefficiently and cause deterioration in application performance. A “bottleneck” can be defined as saturation of a resource's attributes, where it is assumed that a smaller (or bigger) value of an attribute would improve the performance. For example, a bottleneck can be identified from a saturation of txqueue (transmit queue) of a node defined by its parameter txqueuelen (length of the transmit queue). As another example, a bottleneck can be identified from an unusual or abnormal latency of a path that cannot be decreased low enough to improve the performance. An abnormal latency corresponds to the saturation of the sequence of transmission buffers all along the flow path.

When a saturation level is reached, the user may wish to take some action because reaching the saturation level can degrade system performance. The determination of when a saturation level is reached and action is triggered can depend on parameters predefined by the system or specified by the developer or the user of the application. For example, an application developer can specify one or more threshold levels for different resources that when crossed indicate a resource is saturated. The threshold levels that a user specifies may depend on their tolerance for a degradation of system performance that can result as saturation levels are approached. Thus, the threshold levels that are specified for triggering an action may vary from application to application or user to user. In addition, the threshold levels can be application specific depending on how important the performance of the application is to the user.

Managing network resources including bottleneck management is an art. The introduction of the cloud paradigm, for which many aspects of the cloud resources are opaque to a user, introduces new challenges and complexities to managing network resources. For example, in the cloud at any given time, a user may not know the physical locations of their applications on particular devices, the physical communication connections between the devices, and the demands on the resources from other users. In addition, all of these aspects, e.g., physical location, physical connections, and demands from other users, can change as a function of time. Moreover as more mission-critical, complex and large scale applications are deployed in cloud environment, unpredictable and low performance can affect dramatically the business from these applications. As a result, a company can lose thousands of customers and millions of dollars in few minutes. Thus, new tools are needed for network resource management suited to the unique factors associated with a cloud environment, with such new tools allowing for bottleneck anticipation and quick detection in order to remediate them correctly as quickly as possible.

As described herein in some detail, a method and apparatus with a capability to locate and remediate bottlenecks can be provided. In one embodiment, features for discovering and classifying simple problems, such as CPU, memory, and disk problems, which are usually easy to address, can be provided. In addition, features for probing the virtual network at a deeper level, such as the transport layer level (e.g., TCP level), to help to identify and remediate more complex problems can be provided. Features for doing the triage of symptoms to accelerate root cause analysis and appropriate remediation can exploit the knowledge and correlations of classic server metrics with network metrics.

Further, features for helping DevOps define proper alarms and/or automate these alarms, which may be application specific, can be provided. For example, the features can include access to a knowledge database associated with alarms developed from real world applications of the tools. The knowledge database can help a user decide when to act and what is a proper response when an action is taken. The features listed in this paragraph and the previous paragraph can be incorporated into a GUI which enables a user to visualize, locate and remediate network problems, such as bottlenecks. Next, details of these method and apparatus at a high level are provided.

FIG. 10 illustrates a method 1000 for managing bottlenecks interactively. Attributes or metrics that characterize the network of resources and are indicative of possible bottlenecks requiring action may be selected in operation 1002. Then the system can output the metrics in a format, such as visual format that allows a user to detect the bottlenecks in operation 1004.

For example, FIG. 11 shows a flow map 1100 including nodes and flows between the nodes that has been output by the system via a UI. The flow map is one example of a visual format that can be used. As shown in FIG. 11, flow map 1100 can be generated to display congestion or bottleneck events. The flow map 1100 includes 6 nodes (e.g., 1102a-1102f) and 7 flows (e.g., 1104a and 1104b).

The flow map 1100 may include flags that indicate there are problems at two different nodes. The flags are provided for illustrative purpose only as other indicators can also be used to indicate a node problem. Two nodes (1102a and 1102d) and one flow (1104b) are high-lighted because of resource issues. Node 1102a has a CPU usage greater than 90%. A second node 1102d has a disk near capacity. The flow 1104b is identified as having a high latency.

A resource graph 1106 associated with the latency may be displayed to provide additional insight into the latency issue. For instance, resource graph 1106 shows the latency as a function of time, which provides additional insight to a user. Several metrics can be displayed simultaneously as a function of time to detect the root cause of the problem.

The root cause is the resource presenting a metric with an abnormal behavior or a saturation before all the others. In a cloud deployment, rapid cascading effects from failure or bottlenecks can be observed. The dynamic of the system makes the root cause analysis very difficult when done too late. Repairing such a problem too slowly can be also very painful and costly.

As additional or different resources attributes beyond CPU usage, the disk utilization and latency can be used to indicate a possible bottleneck and these metrics are provided for the purposes of illustration only and are not meant to be limiting. Some additional examples of metrics that can be characterized at a node and used to trigger an alarm, alone or in combination with other metrics, include, but are not limited to, total CPU usage, percentage of CPU reclaimed by the hypervisor, percentage of CPU spent waiting for I/O, memory usage, disk I/O usage, NetIn/NetOut usage, capacity at the node interfaces to the virtual network, and txqueue drop at the node interfaces to the virtual network. Some additional examples of parameters that can be characterized for a flow and used to trigger an alarm, alone or in combination with other parameters, include, but are not limited to, the flow data volume which is the amount of data transported by the connections, flow duration which is the duration of the connections within the flow, total number of connections in the flow, flow packet size, count of the number of retransmissions, the flow retransmission time outs, the size of the send queue of the socket corresponding to the connections, the size of the receive queue of the socket corresponding to the connections, and the amount of bandwidth used by the flow. In addition, the flow activity, which can be represented as a topology or heat map, can be utilized. Each of the above quantities can vary as a function of time.

As shown in the example of FIG. 11, the system can allow DevOps to set some alarms and flags. The setting of alarm can include specifying a threshold value or a combination of threshold values for triggering the alarm. The threshold values can vary from node to node and from flow to flow. Optionally, the system may allow a user to turn off an alarm.

The UI can be actionable to allow a user to learn additional information about the identified problems. For example, the user can select a node or a flow, which can cause the UI to generate and display details about the node or the flow. In one embodiment, the system can be configured to collect a user's or application input. The collected input can be used to determine the steps a user has taken to identify a potential bottleneck and the steps the user took to remediate the problem. The collected input can be used for the purposes of automating processes.

In addition, the collected inputs can provide a knowledge base. The knowledge base can be system and/or user searchable. For example, the system and/or the user may search the knowledge base to determine whether a system in a similar configuration has experienced the problems that are currently being detected. If such a system is located, steps that were used to identify and/or remediate the problem can be provided. These steps can be output to the user to allow them to attempt the solution located from the knowledge database if the user desires.

Returning to FIG. 10, the next step can be to diagnose the problem, which can include locating a bottleneck, in operation 1006. A first example of a problem can be the capacity of a link is not sufficient for the application usage. This problem can occur because a queue scheduler does not prioritize the type of flows used by the application. A second of example of a problem can be a txqueue that is dropping packets because it is too small. Thus, the Application “forgets” to read or write data from the socket.

Diagnosing and locating a bottleneck can involve looking at symptoms at different locations within the system to try to narrow down the location of the problem. For example, an application can forget to read or write data from the socket. The bottleneck may be located in the link when it is determined the capacity of the link is not sufficient for the application usage and other possible causes of the bottleneck have been examined and eliminated. Example embodiments of this process are described in more detail with respect to FIGS. 12A-13F.

Referring back to FIG. 10, the system can be configured to allow a remediation action to perform in operation 1008. One type of remediation can involve “cleaning”, which can include killing processes consuming resources, eliminating unexpected communications, and freeing up memory. Another type remediation can be provisioning, which can include changing capacities (capacity limiting usage) or changing location (e.g., to overcome noisy neighbors, infrastructure outage and congestion). Yet another type of remediation can involve configuration modification, which can include changing TCP_NO_DELAY (globally or for the application), which affects Nagle buffering, changing MSS (maximum segment size)/MTU (maximum transmission unit), changing initial retransmission timeout parameter, pacing bursts and changing queue policy. A further type of remediation can involve application modification, which can include grouping connections/sockets, changing an application's architecture, and performing more frequent read/writes.

Next, details of an example of a method for identifying a location of a bottleneck are described with respect to FIGS. 12A-13F. Then, a flow chart of method embodiments with additional details is described with respect to FIGS. 14A, 14B, and 14C.

FIG. 12A illustrates detection of bottlenecks from the output port of a virtual machine of the sender in accordance with one embodiment of the present invention. In FIG. 12A, the network traffic out (NetOut) 1202 at a virtual network interface 1204a of a node 1208 to a virtual network 1206 is determined. The NetOut 1202 is a measure of an amount of data carried in packets sent by the sender 1208. Typically, NetOut 1202 is measured in bytes/sec. The NetOut 1202 may be an aggregate of data carried by a number of connections at the transport layer between the sender 1208 and a set of receivers, e.g., 1210.

In one embodiment, the virtual network 1206 can be a “black box.” In this instance, the system may not be able to obtain any performance measures along the path between the two nodes through this black box virtual network 1206. Thus, if a bottleneck is located in the path, it may not be possible to determine at what location along the path the bottleneck is located. For example, the system does not have access to the state of the buffers (queues) along the network path. However, in other embodiments, some performance measure or other useful metric may be available. In this instance, it may be possible to narrow down a location or segment in the path in which the bottleneck is occurring.

For detecting and analyzing a bottleneck, the first step may be to determine the maximal achievable throughput. When a network is opaque, some assumption can be made, based on the known parameters. In FIGS. 12A (and 12B), the network is opaque from the output port of the virtual machine of the sender 1208 to the input port of the virtual machine of the receiver 1210. But the output capacity of the sender 1208 and the input capacity of the receiver 1210 are known. In FIG. 12A, the output capacity of the sender 1208 is less than the input capacity of the receiver 1210. Thus, it should be possible for the sender 1208 to output data at its maximum capacity. As the capacity of the path between the output interface 1204a of the sender 1208 and the input interface 1204b of the receiver 1210 is unknown, the system decides that the maximum capacity of the path is equal to the output capacity of the sender 1208.

During the usage of this path by a flow, the system can determine if the flow is getting less than some fraction of the maximum value of the path capacity, such as less than 90% or less than 50%. Based on this factor, it is assumed there is some bottleneck in the network between the sending application module and the receiving application module. When a determination is made of a bottleneck, an attempt can be made to locate the bottleneck as is described in more detail with respect to FIGS. 13A-13F.

In FIG. 12B, the input capacity of the receiver 1210 is less than the output capacity of the sender 1208. Thus, it should not be possible for the sender to output data at its maximum capacity. In this example, the capacity of the path between the output interface of the sender and the input interface of the receiver is unknown. In this condition, the system decides that the maximum capacity of the path is determined by the input capacity of the receiver 1210. The communications between the sender node 1208 and the receiver node 1210 are modeled as flow. The limitation is that the receiver input capacity is less than the sender output capacity. Thus, the sender should be able to send data at near the receiver input maximum capacity. However, when a determination is made that the flow throughput is less than some threshold value, a determination can be made that there is some bottleneck in the system between the sending application module node and the receiving application. Next, the system can be configured to attempt to locate automatically and/or guide the user through the process of finding the bottleneck. For example, the user can be guided through the process via a UI. Details of this process are described as follows.

With respect to FIG. 13A, first the receiver node 1310 can be checked. The system can be configured to present resource attributes (symptoms) to a user that allows the user to determine whether the bottleneck (e.g., 1311) is located within the receiver node 1310. The system can also be configured to perform this check automatically. Some symptoms that may be observed from data output via the system are that the CPU, memory and/or I/O capacity of the receiver is insufficient to receive traffic when the sender 1308 is ready to send data. The system knows that data are waiting to be sent because the socket buffer of the sender 1308 is not empty. Based upon these symptoms, the user and/or the system automatically may determine that the receiver node 1310 is overloaded and the bottleneck 1311 is in the receiver node 1310. When the determination is made that the bottleneck 1311 is in the receiver node 1310 and due to some computing resource limitations, then the system can be configured to allow the user to take a remedial action. In addition, the system may recommend one or more remedial actions for the user to take. The system can also be configured in such a way that it automatically performs the remediation. These remediations can be associated to a cost and the system can decide the actions based on some cost constraints.

When the symptoms that are observed at the receiver node 1310 are inconsistent with the bottleneck being the receiver node 1310, then the system can be configured to allow a user to check the computing resource of the sender node 1308 as shown in FIG. 13B. The system can also be configured to perform measurements that characterize the sender node 1308. In one instance, the measurements can be consistent with flow starvation where the CPU, memory and/or I/O capacity are insufficient to send traffic and the socket buffer is not empty. Based upon these symptoms, a user and/or the system may determine that there is a bottleneck 1307 inside the sender node 1308 due to some computing resource limitations. When the determination is made that the bottleneck 1307 is inside the sender node 1308 itself, then the system can be configured to allow the user to take a remedial action. In addition, the system may recommend one or more remedial actions for the user to take. The system can also be configured such a way that it automatically performs the remediation. These remediations can be associated to a cost and the system can decide the actions based on some cost constraints.

Next, when it is concluded the computing resource limitations of sender node is not the source of the bottleneck, the system can provide measurements that allow the user to investigate the transport layer of the receiver node. As an example, in FIG. 13C, receiver 1310 is shown as a destination for two flows from each of sender #1 (1308a) and sender #2 (1308b). When multiple flows are terminate in the same receiver, the network cross traffic can cause the network stack buffer in the receiver to fill up. Based upon measurements associated with the receiver network stack, a user and/or the system may determine that the bottleneck 1314 is in the receiver network stack. In response, the system can be configured to allow the user perform a remedial action. For example, the user via a GUI may be able to increase the buffer size of the network stack. In some embodiments, this action can be performed automatically by the system.

When the problem is determined not to be due to some computing resource limitations in the sender node, the system can also be configured to generate an interface that allows a user to examine the sender network stack. In FIG. 13D, the sender 1308 originates two flows to two separate receivers 1310a and 1310b. When the sender's network stack is not well configured, its output queues can be become saturated while the socket buffer of sender connection is not empty. This scenario can be revealed to a user via data output in the UI. Based on data generated by the system, the user and/or the system can conclude that the bottleneck 1316 is in the network stack of the sender 1308. In response, the system can generate a user interface that allows the user to take a remedial action, such as reconfiguring the network stack. In some embodiments, this action may be automatically performed by the system.

Next, when the sender's network stack is concluded not to be the source of the bottleneck, the system can be configured to generate an interface that allows a user to examine the sender's output port or a receiver's input port. The sender's output port or a receiver input port can be a virtual network interface to the virtual network. In FIG. 13E, an example is shown where the sender's output port is shared by two flows. The cross traffic from the flows causes the output port to become saturated while the sender connection is not empty.

The system can be configured to output information that allows a user to identify the cross traffic problem in the output port. The output information can enable the user and/or the system to conclude that the bottleneck 1318 is in the sender's output port. The user can confirm their conclusion via an input to the system, which can cause the system to generate an interface state that allows the user to perform a remedial action or in some embodiments, the system may automatically perform the remedial action.

When the sender's output port is determined not to be a problem, the receiver's input port can be checked in a similar manner to the sender's output port. When the receiver's input port is determined not to be problem, then the user and/or the system can determine that the bottleneck 1320 is in the path through the virtual network 1306. For example, in FIG. 13F, heavy external cross traffic in the virtual network 1306 is causing a bottleneck 1320 in the path between the sender #1 (1308a) and receiver #1 (1310a). The bottleneck 1320 manifests as path saturation.

When the virtual network 1306 is a black box, the user may not be able to take a remedial action that affects the virtual network 1306. Instead, to address the bottleneck, the user may perform an action, such as moving the resource to another location which changes the path and hopefully lessens or removes the bottleneck. In other embodiments, some access can be provided to the virtual network. The access to virtual network may allow a user to view metrics associated with the path and devices in the virtual network. This information can be used to narrow down a location in the path where the bottleneck is occurring. In some embodiments, if available, the system can be configured to enable a user to perform a remedial action that affects the virtual network. In some instance, the remedial action can be performed automatically by the system. Next, a more general and automated method for locating and remediating bottlenecks very rapidly is described with respect to FIGS. 14A, 14B and 14C.

FIGS. 14A, 14B, and 14C illustrate one embodiment of a process for locating bottlenecks in a system deployed in the cloud is shown. In FIG. 14A, the method can start with a check of the receiver node at the application layer (L7), for example, in operation 1402. The system can check thresholds which may be user specified in regards to whether the CPU usage (1404a), the memory usage (1404b), I/O usage (1404c), or the disk usage (1404d) is too high. In the example in the FIG. 14A, the threshold for a usage amount being too high is greater than 90% of its maximum value over 1 minute. These parameters are provided for the purposes of illustration as additional or different combinations of parameters can be examined. For example, a single parameter that is a weighted function of the CPU usage, memory usage, I/O usage and disk usage may be utilized.

A check can also be made of whether the receiver is ok in operation 1406. In the example in the figure, the receiver may not be considered ok if any of thresholds are exceeded and considered ok if none of the thresholds are exceeded. When the receiver is determined not to be ok, the communication in the application layer, e.g., L7, can be checked to determine whether there is a problem in operation 1408. In one embodiment, whether a communication problem exists can be determined from the value of the receive queue of the network stack, which denotes that the application is not able to consume the arriving data.

When a check of this parameter indicates there is a problem, a message can be sent or output by the system that there is a communication bottleneck on the receiver in operation 1409. This message can be indicated visually (graphically and/or textually), as well as auditorily, to a user, such as within a GUI. In one embodiment, a recommendation can be made to change the receiver instance type to fix the problem. Changing the instance type will give, for example, more computing capacity for both processing and receiving data.

When it is determined that there is not a communication problem, the system can check whether there is problem with the load balancer (of the receiver) in operation 1410. The system can detect that the receiver is a load balancer and whether there is a problem with such load balancer. When it is determined there is a problem with the receiver load balancer, the system can send a message that there is a processing bottleneck on the receiver in operation 1411. The load balancer is not able to process the traffic it receives at the right speed. In one embodiment, a recommendation can be made to add another load balancer to fix or change the receiver instance to fix the problem.

When the system determines there is not a problem with the load balancer, the system can be configured to check load balancing targets other than the receiver in operation 1412. For example, the CPU usage, the memory usage, the I/O disk usage and the disk usage can be checked to determine whether any of these quantities exceed a threshold (1404a-1404d). If any of the thresholds are exceeded (1414), the system can generate a message indicating there is a processing bottleneck on the receiver in operation 1416. In one embodiment, the system can generate a recommendation to balance the load, e.g., add targets to the load balancer. If none of the thresholds are exceeded (1414), the system can generate a message to indicate there is processing bottleneck on the receiver in operation 1415. In one embodiment, the system can generate and output a recommendation to reconfigure the load balancer.

In FIG. 14B, when it is determined there is not a problem with the receiver at the application layer (in operation 1406), such as when none of the checked thresholds are exceeded, the system can be configured to check the sender at the application layer in operation 1418. Like the receiver, one or more parameters can be determined and compared to a threshold value in operations 1424a-1424d. If any of the threshold values are crossed (in 1426), a determination can be made if there is communication problem in the application layer (L7) in operation 1428, such as by using the same check as described above for the receiver.

When it is determined that there is a communication problem in the application layer, the system can generate and output a message indicating that there is a communication bottleneck on the sender in operation 1429b. In one embodiment, a recommendation can be generated and output indicating changing the sender instance type may be a solution. When it is determined that the problem is not in the application layer of the sender, the system can be configured to generate a message indicating that there is processing bottleneck on the sender in operation 1429a. A recommendation can be generated that indicates adding a load balancer or changing the sender instance type may fix the problem.

In FIG. 14C, when it is determined the sender at the application layer is ok, e.g., none of the thresholds associated with one or more parameters were crossed (in operation 1426 of FIG. 14B), the system can be configured to check the path in operation 1427. In one embodiment, the transport layer (e.g., TCP) in the receiver can be checked to determine whether the TCP in the receiver is well configured in operation 1434. Different parameters can be misconfigured in TCP, such as receive buffer size. Detecting and analyzing a problem is complex because there exist many variants of the TCP protocol and each scenario is different. Only TCP experts empowered with appropriated metrics and information know how to configure this protocol optimally in a specific scenario. To help non-experts detect and remediate TCP misconfiguration, the system encodes the knowledge of the TCP experts and provides the needed instrumentation and analysis. When it is determined that the TCP in the receiver is not well configured, the system can be configured to generate and output a message indicating that there is a communication bottleneck on the receiver and the TCP of the receiver is not well configured in operation 1435a. In one embodiment, a recommendation can be generated to detail how to reconfigure the TCP of the receiver. The reconfiguration can also be automated and performed by the system itself.

When it is determined that the TCP receiver is well configured, the system can check whether the TCP sender is well configured in operation 1436. In one embodiment, the condition for determining whether the TCP sender is well configured is, for example, the socket buffer size which should be sized in relation with the path capacity and path latency. When it is determined that the TCP sender is not well configured, the system can be configured to generate a message indicating that there is a communication bottleneck on the sender TCP because the sender TCP is not well configured in operation 1435b. In one embodiment, a recommendation can be generated indicating the reconfiguring the TCP of the receiver may fix the bottleneck.

When it is determined that there is not a problem with the path, then the system can configured to check whether there is a problem with the sender (1438). Specifically, it may be determined whether there is a problem at the transport layer (L4) of the sender in operation 1440. In this embodiment, the TCP send queue is checked to determine whether it is greater than zero over 1 minute. The parameter can be based upon a check of all of the connections. When it is determined that there is not a problem in the transport layer of the sender, the system can be configured to check whether there is a problem in the network layer (L3) at the sender in operation 1454. Based upon all of the connections, a determination can be made of the number of requeued packets that have occurred over a time period, such as one minute. When the value is greater than the zero or some threshold value, the system can determine that there is a problem and generate a message descriptive of the problem. In one embodiment, a recommendation can be made to change the instance type as a possible fix to the problem in operation 1435g.

When it is determined that there is not a network layer L3 problem, the system can be configured to determine whether there is a latency problem in the network path in operation 1456. In one embodiment, the check for a latency problem can be if the value of the TCP round trip time (TCP_RTT) is greater than 10 ms during 1 minute when summed over all the connections. When it is determined that there is not a latency problem, a message can be generated that everything is ok in operation 1435j. When it is determined there is a latency problem, the system can be configured to generate and output a message indicating there is a latency problem on the external path in operation 1435h. In one embodiment, a recommendation can be made to move the sender and receiver to the same active zone to fix the problem.

When there is a problem with the transport layer L4 in the sender (in operation 1440), the system can be configured to check if there is a problem in the network layer (L3) of the sender in operation 1442. In one embodiment, the condition for determining whether there is a problem can be based on a number of requeued packets over a minute in view of all the connections. When it is determined there is a network layer L3 problem, the system raises a condition associated with the load balancer and explores if the sender is a load balancer in operation 1444.

When it is determined that there is a load balancer problem, the system can be configured to generate a message that there is communication bottleneck on the receiver, e.g., congestion, in operation 1435c. In one embodiment, the system can generate an output a message indicating that changing the load balancer configuration may fix the problem. When it is determined that there is not a load balancer problem, the system can be configured to generate and output a message indicating that there is a communication bottleneck on the receiver, e.g., congestion, in operation 1435d. In one embodiment, the system can be configured to generate and output a recommendation to add a load balancer or change the instance type.

When it is determined that there is not an transport layer L4 or network layer L3 problem at the sender, the system can be configured to determine whether there is a problem in the application layer (L7) at the sender in operation 1446. In one embodiment, the condition can be a check of whether the TCP receive window is equal to zero during 1 minute over all of the connections. When a determination is made that there is an application layer L7 problem, the system can be configured to generate a message indicating that there is an application bottleneck because the receiver is not processing data fast enough in operation 1435e.

When it is determined that there is not an application layer L7 problem, the system can be configured to check whether there is a congestion problem in the external network in operation 1448. This check can involve determining the number of retransmission time outs (RTO)s and the number of retransmissions over a time period over all of the connections. When it is determined that there is not congestion, the latency can be checked as described above in operation 1446.

When it is determined that there is congestion, the receiver can be checked in operation 1450. First a check can be made as to whether there is a problem in the receiver network layer L3 in operation 1452. One check can be whether the number of requeued packets is greater than zero over some time period and over all of the connections. When it is determined that there is an L3 problem in the receiver, the system can be configured to generate a message indicating there is a communication bottleneck on the sender as a result of congestion in operation 1435f. In one embodiment, a recommendation can be made to change the instance type of the sender. When it is determined that there is not a problem in the network layer L3, the system can be configured to generate a message indicating that there is a communication bottleneck on the external path in operation 1435i. In one embodiment, a recommendation can be made to move the sender which may require stopping and starting of the instance.

In one embodiment, if the communication bottleneck is on the external path and system is able to see any portion of the external network and possibly control portions of the external network, then the system can be configured to generate metrics that allow a user to locate a source of the bottleneck in the network. The system can be configured to look at the metrics at the various endpoints of links to determine whether there is a bottleneck in the link. When a bottleneck is identified, the system can be configured to generate and output a recommended remedial action.

The various aspects, embodiments, implementations or features of the described embodiments can be used separately or in any combination. The systematic examination of the cause of a bottleneck by combining the processes of FIGS. 12A-12C can provide a maximum acceleration of the process. This resulting flow tree can encode the methodology a network expert would adopt to detect, locate and remediate such bottleneck, but in a minimum time.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method in an electronic device including a processor and a memory, the method comprising:
identifying in the processor virtual resources associated with an execution of a user's applications in a resource configuration, including virtual or physical machines, network services, and storage, wherein the resource configuration is a cloud or distributed resource configuration;
generating a plurality of performance metrics associated with the execution of the user's applications in the resource configuration;
generating in the processor a visual representation of the resource configuration including the virtual or physical machines and the performance metrics;
outputting under control of the processor a user interface including the visual representation;
determining in the processor that there is possibly a bottleneck involving a sender and a receiver of the virtual or physical machines based on the performance metrics;
checking serially in the processor for a problem indicating a presence of the bottleneck in each of an application layer, transport layer, and network layer of the sender and the receiver;
when a check indicates the problem is in one of the application layer, transport layer, or network layer of the sender or the receiver, stopping in the processor the checking and outputting a message to the user interface indicating a location of the bottleneck is in the sender or receiver and a recommendation for a remedial action for alleviating the bottleneck; and
when the checks indicate the problem is not located in any of the application layer, transport layer, or network layer of the sender or the receiver, outputting by the processor a message to the user interface indicating the location of the bottleneck is in an external path between the sender and the receiver and a recommendation for a remedial action for alleviating the bottleneck in the external path or there is no problem.

2. The method of claim 1, wherein checking comprises checking a CPU usage, memory usage, disk usage, and/or latency metric of the receiver or sender.

3. The method of claim 2, wherein checking further comprises checking one or more metrics pertaining to the receiver or the sender: a total CPU usage, percentage of CPU that is reclaimed, percentage of CPU spent waiting for I/O, disk I/O usage, NetIn/NetOut usage, capacity at an interface of the receiver or sender interfaces to a virtual network, and a transmit queue drop at the interface of the receiver or sender to the virtual network.

4. The method of claim 2, wherein checking further comprises checking one or more flow metrics of one or more flows between the receiver and the sender: an amount of data transported by a plurality of connections within the one or more flows, a duration of the connections within the one or more flows, a total number of connections in the one or more flows, a flow packet size, a count of the number of retransmissions, flow retransmission time outs, a size of a send queue of a socket corresponding to the connections, a size of a receive queue of the socket corresponding to the connections, and an amount of bandwidth used by the one or more flows.

5. The method of claim 4, wherein the one or more flow metrics further comprise a flow activity metric, wherein one or more flow metrics vary over time.

6. The method of claim 1, further comprising:
collecting the user's input for remediating the bottleneck; and
providing a knowledge database based on the collected user input and the problem, wherein the knowledge database is user searchable to allow the user to determine whether a system in a similar configuration has experienced a same problem.

7. The method of claim 1, wherein the resource configuration includes an opaque network that includes the external path between an output port of the sender and an output port of the receiver from which performance metrics cannot be determined, wherein the performance metrics upon which the determining of the bottleneck is based include a data output capacity of the sender and a data input capacity of the receiver, and wherein checking comprises:
if the data output capacity of the sender is below the data input capacity of the receiver, defining the output capacity of the sender as a maximum data path capacity for a flow of data from the sender to the receiver;
if the data input capacity of the receiver is less than the data output capacity of the sender, defining the input capacity of the receiver as a maximum data path capacity for a flow of data from the sender to the receiver; and
if a data usage by a flow of data from the sender to the receiver is below a predefined fraction of the maximum path capacity, determining the problem is located between an application module of the sender and an application module of the receiver.

8. The method of claim 7, wherein the performance metrics upon which the determining of the bottleneck is based include an indicator of a CPU, memory, and/or I/O capacity of both the receiver and sender, and wherein checking further comprises:
if the indicator indicates that the CPU, memory, and/or I/O capacity of the receiver is insufficient to receive data when the sender is ready to send data to the receiver, determining the problem is located in the receiver; and
if the indicator indicates that the CPU, memory, and/or I/O capacity of the sender is insufficient to send data to the receiver, determining the problem is located in the sender.

9. The method of claim 1, wherein checking further comprises:
if a particular one or more of the performance metrics indicate that a CPU usage, memory usage, I/O usage, or a disk usage of the receiver is above a predefined threshold, determining whether the problem is in the application layer of the receiver; and
if it is determined that the problem is in the application layer of the receiver, stopping the checking of the transport and network layer of the receiver and sender and outputting a message indicating a location of the bottleneck in the receiver in the form of a communication bottleneck and also indicating a recommendation for changing a receiver instance type.

10. The method of claim 9, wherein it is determined that the problem is in the application layer in the receiver if a value of a receive queue of a network stack of the receiver denotes that an application of the receiver is not able to consume arriving data.

11. The method of claim 9, wherein the checking further comprises:
if it is determined that the problem is not in the application layer of the receiver, checking whether the problem is a load balancer problem; and
if it is determined that the problem is a load balancer problem, stopping the checking of the transport and network layer of the receiver and sender and outputting a message indicating a location of the bottleneck in the receiver in the form of a processing bottleneck and also indicating a recommendation for adding another load balancer or change a receiver instance.

12. The method of claim 10, wherein the checking further comprises:
if it is determined that the problem is not a load balancer problem, checking whether the problem is another load balancing problem in another load balancing target, other than the receiver;
if it is determined that the problem is another load balancing problem, stopping the checking of the transport and network layer of the receiver and sender and outputting a message indicating a location of the bottleneck in the receiver in the form of a processing bottleneck and also indicating a recommendation for balancing load; and
if it is determined that the problem is not in another load balancing problem, stopping the checking of the transport and network layer of the receiver and sender and outputting a message indicating a location of the bottleneck in the receiver in the form of a processing bottleneck and also indicating a recommendation for reconfiguring a load balancer.

13. The method of claim 12, wherein it is determined that the problem is another load balancing problem if a one or more of the performance metrics indicate that a CPU usage, memory usage, I/O usage, or a disk usage of the receiver is above a predefined threshold.

14. The method of claim 9, wherein the checking further comprises:
if it is determined that the problem is not in the application layer of the receiver and if a particular one or more of the performance metrics indicate that a CPU usage, memory usage, I/O usage, or a disk usage of the sender is above a predefined threshold, determining whether the problem is in the application layer of the sender;
if it is determined that the problem is in the application layer of the sender, stopping the checking of the transport and network layer of the receiver and sender and outputting a message indicating a location of the bottleneck in the sender in the form of a communication bottleneck and also indicating a recommendation for changing a sender instance type; and
if it is determined that the problem is not in the application layer of the sender, stopping the checking of the transport and network layer of the receiver and sender and outputting a message indicating a location of the bottleneck in the sender in the form of a processing bottleneck and also indicating a recommendation for adding a load balancer or changing a sender instance type.

15. The method of claim 14, wherein the checking further comprises:
if a particular one or more of the performance metrics indicate that a CPU usage, memory usage, I/O usage, or a disk usage of the sender is not above a predefined threshold, checking whether the problem is in the transport layer of the receiver and the sender to determine if the transport layer protocol of the receiver or sender is misconfigured;
if it is determined that the transport layer protocol of the receiver is misconfigured, stopping the checking of the transport and network layer of the receiver and sender and outputting a message indicating a location of the bottleneck in the receiver in the form of a communication bottleneck and also indicating a recommendation for reconfiguring the transport layer of the receiver; and
if it is determined that the transport layer protocol of the sender is misconfigured, stopping the checking of the transport and network layer of the receiver and sender and outputting a message indicating a location of the bottleneck in the sender in the form of a communication bottleneck and also indicating a recommendation for reconfiguring the transport layer of the sender.

16. The method of claim 15, wherein the transport layer protocol of the receiver is misconfigured based on the receive buffer size, and wherein the transport layer protocol of the sender is misconfigured if a socket buffer size of the sender is not sized in relation with a path capacity and path latency of the external path.

17. The method of claim 14, wherein the checking of the transport layer protocol of the receiver is checked before checking the transport layer protocol of the sender and the checking of the transport layer protocol of the sender is only performed if it is determined the problem is not in the transport layer protocol of the receiver.

18. The method of claim 14, wherein the checking further comprises:
(a) if it is determined that transport layer protocol of the receiver or sender is not misconfigured, checking whether the problem is in the transport layer of the sender;
(b) if it is determined that the problem is not in the transport layer of the sender, checking whether the problem is in the network layer of the sender;
(c) if it is determined that the problem is in the network layer of the sender and not in the transport layer of the sender, stopping the checking of the transport and network layer of the receiver and sender and outputting a message indicating a location of the bottleneck in the network layer of the sender and also indicating a recommendation for changing a sender instance type;
(d) if it is determined that the problem is not in the network layer of the sender and not in the transport layer of the sender, checking whether the problem is a latency problem in the external path;
(e) if it is determined that the problem is not a latency problem in the external path, outputting a message indicating that there is no problem;
(f) if it is determined that the problem is a latency problem in the external path, stopping the checking of the transport and network layer of the receiver and sender and outputting a message indicating a location of the bottleneck in the external path in the form of a latency problem and also indicating a recommendation for moving the receiver and sender;
(g) if it is determined that the problem is in the network layer and the transport layer of the sender, determining if the sender is a load balancer;
(h) if it is determined that the problem is in the network layer and the transport layer of the sender and it is determined that the sender is a load balancer, stopping the checking of the transport and network layer of the receiver and sender and outputting a message indicating a location of the bottleneck in the receiver in the form of a communication and congestion bottleneck and also indicating a recommendation for changing the load balancer configuration;
(i) if it is determined that the problem is in the network layer and the transport layer of the sender and it is determined that the sender is not a load balancer, stopping the checking of the transport and network layer of the receiver and sender and outputting a message indicating a location of the bottleneck in the receiver in the form of a communication and congestion bottleneck and also indicating a recommendation for adding a load balancer or changing an instance type;
(j) if it is determined that the problem is not in the network layer and the transport layer of the sender, determining whether the problem is in the application layer of the sender;
(k) if it is determined that the problem is not in the network layer and the transport layer of the sender and it is determined that the problem is in the application layer of the sender, stopping the checking of the transport and network layer of the receiver and sender and outputting a message indicating a location of the bottleneck in the receiver in the form of an application bottleneck; and
(l) if it is determined that the problem is not in the network layer and the transport layer of the sender and it is determined that the problem is not in the application layer of the sender, checking whether the problem is a congestion problem in the external path;
if it is determined that the problem is not a congestion problem in the external path, repeating operation (d)˜(f);
if it is determined that the problem is a congestion problem in the external path, checking whether the problem is in the network layer of the receiver;
if it is determined that the problem is in the network layer of the receiver, stopping the checking of the transport and network layer of the receiver and sender and outputting a message indicating a location of the bottleneck in the sender in the form of a communication and congestion bottleneck and also indicating a recommendation for changing an instance type; and
if it is determined that the problem is not in the network layer of the receiver, stopping the checking of the transport and network layer of the receiver and sender and outputting a message indicating a location of the bottleneck in the external path in the form of a communication and congestion bottleneck and also indicating a recommendation for moving the sender.

19. The method of claim 1, wherein the message indicating a location of the bottleneck or the message indicating the location of the bottleneck is in the external path is output with respect to the visual representation.

20. The method of claim 1, wherein a bottleneck in the sender or receiver or a bottleneck in the external path prevents the resource configuration from operating at a particular threshold of full capacity.

21. An apparatus for cloud or distributed computing resource management, the apparatus formed from one or more electronic devices that are configured to perform the following operations:
identifying virtual resources associated with an execution of a user's applications in a resource configuration, including virtual or physical machines, network services, and storage, wherein the resource configuration is a cloud or distributed resource configuration;
generating a plurality of performance metrics associated with the execution of the user's applications in the resource configuration;
generating a visual representation of the resource configuration including the virtual or physical machines and the performance metrics;
outputting under control a user interface including the visual representation;
determining that there is possibly a bottleneck involving a sender and a receiver of the virtual or physical machines based on the performance metrics;
checking serially for a problem indicating a presence of the bottleneck in each of an application layer, transport layer, and network layer of the sender and the receiver;
when a check indicates the problem is in one of the application layer, transport layer, or network layer of the sender or the receiver, stopping the checking and outputting a message to the user interface indicating a location of the bottleneck is in the sender or receiver and a recommendation for a remedial action for alleviating the bottleneck; and
when the checks indicate the problem is not located in any of the application layer, transport layer, or network layer of the sender or the receiver, outputting a message to the user interface indicating the location of the bottleneck is in an external path between the sender and the receiver and a recommendation for a remedial action for alleviating the bottleneck in the external path or there is no problem.

22. At least one computer readable storage medium having computer program instructions stored thereon that are arranged to perform the following operations:
identifying in a processor virtual resources associated with an execution of a user's applications in a resource configuration, including virtual or physical machines, network services, and storage, wherein the resource configuration is a cloud or distributed resource configuration;
generating a plurality of performance metrics associated with the execution of the user's applications in the resource configuration;
generating in the processor a visual representation of the resource configuration including the virtual or physical machines and the performance metrics;
outputting under control of the processor a user interface including the visual representation;
determining in the processor that there is possibly a bottleneck involving a sender and a receiver of the virtual or physical machines based on the performance metrics;
checking serially in the processor for a problem indicating a presence of the bottleneck in each of an application layer, transport layer, and network layer of the sender and the receiver;
when a check indicates the problem is in one of the application layer, transport layer, or network layer of the sender or the receiver, stopping in the processor the checking and outputting a message to the user interface indicating a location of the bottleneck is in the sender or receiver and a recommendation for a remedial action for alleviating the bottleneck; and
when the checks indicate the problem is not located in any of the application layer, transport layer, or network layer of the sender or the receiver, outputting by the processor a message to the user interface indicating the location of the bottleneck is in an external path between the sender and the receiver and a recommendation for a remedial action for alleviating the bottleneck in the external path or there is no problem.
